(19) United States
(12) Patent Application Publication
(10) Pub. No.: US 2016/0115068 A1
(43) Pub. Date: Apr. 28, 2016

(54) METHOD FOR SCRIBING TEMPERED GLASS SHEET

(71) Applicant: NIPPON ELECTRIC GLASS CO., LTD., Shiga (JP)

(72) Inventors: Hiroyuki NAKATSU, Shiga (JP); Hisahiro TAKEUCHI, Shiga (JP); Kiyotaka KINOSHITA, Shiga (JP)

(21) Appl. No.: 14/896,836

(22) PCT Filed: Jun. 26, 2014
(86) PCT No.: PCT/JP2014/067071

§ 371 Date: Dec. 8, 2015

(30) Foreign Application Priority Data
Jun. 27, 2013 (JP) 2013-135008
Jun. 27, 2013 (JP) 2013-135010
Jun. 27, 2013 (JP) 2013-135012

(51) Int. Cl. C03B 33/04; B26D 3/08

(52) U.S. Cl. CPC C03B 33/04; B26D 3/085

(57) ABSTRACT

When forming a scribe line along a preset cutting line serving as a boundary between an effective surface portion and a non-effective surface portion, a preparatory scribe line to be smoothly joined to the preset cutting line while being curved from the non-effective surface portion to the preset cutting line is formed using a scribing wheel, and then the scribe line that continues from the preparatory scribe line is formed using the scribing wheel. Further, an auxiliary scribe line extending toward the scribe line with the non-effective surface portion being a starting end of the auxiliary scribe line, and having a terminal end prevented from being joined to the scribe line is formed with use of the scribing wheel.

### TECHNICAL FIELD

The present invention relates to a method of scribing a tempered glass sheet, which involves forming a scribe line for cutting the tempered glass sheet by moving a scribing blade.

### BACKGROUND ART

As is well known, tempered glass sheets are obtained by tempering their surface layer regions through ion exchange or air cooling tempering so that compressive stress layers having compressive stress applied thereto are formed on a front surface side and a back surface side of each of the tempered glass sheets in their thickness direction. Further, a tensile stress layer having tensile stress applied thereto is formed between the compressive stress layers on both sides. As compared to normal glass sheets, the fracture strength of the tempered glass sheets against the tensile stress to be applied to each of the surface layer regions is enhanced significantly.

To cutout the tempered glass sheet into a product size, for example, the following method has widely been employed. That is, a scribing wheel is moved to press the front surface of the tempered glass sheet along a preset cutting line, to thereby form a scribe line (see Patent Literature 1). Note that, the scribe line includes a median crack extending in the thickness direction of the tempered glass sheet and serving as a starting point for cutting the tempered glass sheet. After that, bending moment is applied onto the periphery of the scribe line to snap the tempered glass sheet, to thereby obtain the tempered glass sheet having the product size.

### CITATION LIST

Patent Literature 1: JP 2012-031018 A

### SUMMARY OF INVENTION

### Technical Problem

Incidentally, the tempered glass sheet has been employed as, for example, a cover glass of a display in smartphones, tablet PCs, and the like, which have rapidly become widespread in recent years. In this case, unlike rectangular tempered glass sheets that have been mass-produced hitherto, the tempered glass sheet employed in those products may have a shape in which a part of an outer peripheral profile or an entire outer peripheral profile of the tempered glass sheet is defined by a curved line.

As a typical example of the tempered glass sheet having such an outer peripheral profile, there is given a tempered glass sheet having a substantially rectangular shape including curved corner portions C as illustrated in FIG. 23 (this shape is hereinafter referred to as “typical shape”). In obtaining such a shape, hitherto, there has been used a method involving cutting out a rectangular tempered glass sheet G having a small area from a tempered glass sheet having a large area, and then grinding the corner portions C to form each of the corner portions C into a round shape, to thereby obtain the typical shape.

However, in the case of using the related-art method, it takes a considerable length of time for grinding the corner portions C. Therefore, the productivity is liable to lower, and a significant burden is imposed on a grinding tool for performing grinding. Further, the tempered glass sheet G may be cracked during grinding due to the tensile stress applied to the tensile stress layer of the tempered glass sheet G. Therefore, as a method of obtaining a tempered glass sheet having a typical shape and other tempered glass sheets each having an outer peripheral profile including a curved line, an attempt has been made to employ a novel method described below.

That is, in the novel method, as indicated by the blank arrow in FIG. 24, a preparatory scribe line RS starts being formed from a non-effective surface portion Gb to be discarded after cutting, with a scribing wheel H, in the tempered glass sheet G having a small area cut out from the tempered glass sheet having a large area. Then, the preparatory scribe line RS is joined at a point J to a preset cutting line CL having a closed-loop shape and serving as a boundary between an effective surface portion Ga to be cut out and the non-effective surface portion Gb surrounding the effective surface portion Ga. After that, a scribe line S that continues from the preparatory scribe line RS is formed into a closed-loop shape by moving the scribing wheel H along the preset cutting line CL.

Then, bending moment is applied onto the peripheries of the preparatory scribe line RS and the scribe line S, which have been formed, to cut the tempered glass sheet G by snapping into the effective surface portion Ga and the non-effective surface portion Gb, to thereby cut out a desired shape as the effective surface portion Ga. According to the novel method, it is possible to suitably avoid the occurrence of trouble in the above-mentioned related-art method.

However, there still remains a problem to be solved in the novel method. That is, as indicated by the blank arrow in FIG. 25 (enlarged view of a portion L illustrated in FIG. 24), when the preparatory scribe line RS is joined to the preset cutting line CL at the point J and then the forming of the scribe line S that continues from the preparatory scribe line RS is started, it is necessary to abruptly change the moving direction of the scribing wheel H at the point J.

Therefore, when the moving direction of the scribing wheel H is changed, the wheel H is forcibly subjected to unnatural rotation, and due to this, cracks K extending in various directions are generated in the vicinity of the point J. As a result, when the tempered glass sheet G is snapped, the tempered glass sheet G may be cut along the crack K extending in a direction different from the scribe line S in the cracks K instead of the scribe line S, and as illustrated in FIG. 26, there is a problem in that an uncut portion W is liable to be generated in the effective surface portion Ga.

Note that, the above-mentioned problem occurs similarly when the effective surface portion is cut out from the tempered glass sheet having any shape (other than a rectangular shape), as well as when the effective surface portion having an outer peripheral profile including a curved line is cut out from the rectangular tempered glass sheet as described above.

The present invention has been made in view of the above-mentioned circumstances, and it is therefore a first technical object of the present invention to suppress generation of an uncut portion in an effective surface portion having an outer peripheral profile including a curved line when cutting out the effective surface portion from a tempered glass sheet.

The above-mentioned novel method further has the following problem. That is, the scribe line S that has been formed in the tempered glass sheet G includes curved parts, which are curved along the corner portions C in four positions of the effective surface portion Ga, in addition to linear parts extending linearly in a vertical direction and a horizontal direction.

Thus, when the effective surface portion Ga and the non-effective surface portion Gb are cut by snapping, it is necessary to apply bending moment for executing the snapping along the curved parts of the scribe line S at four positions in a direction corresponding to each curved part in addition to bending moment for executing the snapping along the linear parts of the scribe line S, thereby being essential to bend the tempered glass sheet G simultaneously in various directions. As a result, the opposing cut surfaces of the effective surface portion Ga and the non-effective surface portion Gb are brought into contact with each other during the execution of snapping, thereby causing such a situation that the quality of the cut surfaces is significantly degraded due to the generation of cracks and the like.

Note that, the above-mentioned problem occurs similarly when the effective surface portion is cut out from the tempered glass sheet having any shape (other than a rectangular shape), as well as when the effective surface portion having an outer peripheral profile including a curved line is cut out from the rectangular tempered glass sheet as described above.

The present invention has been made in view of the above-mentioned circumstances, and it is therefore a second technical object of the present invention to suppress contact between opposing cut surfaces of an effective surface portion and a non-effective surface portion to the extent possible when cutting a tempered glass sheet by snapping into the effective surface portion having an outer peripheral profile including a curved line and the non-effective surface portion surrounding the effective surface portion.

The above-mentioned novel method further has the following problem. That is, as described above, when the tempered glass sheet G is cut by snapping, it is necessary to apply the bending moment for executing the snapping along the curved parts of the scribe line S at the four positions in the direction corresponding to each curved part in addition to the bending moment for executing the snapping along the linear parts of the scribe line S. Due to the foregoing, there is a problem in that the effective surface portion Ga cannot be smoothly cut out, for example, the effective surface portion Ga and the non-effective surface portion Gb are not separated suitably at the curved parts at the four positions, merely by applying the bending moment onto the periphery of the scribe line S.

Note that, the above-mentioned problem occurs similarly, for example, in the case of cutting out a shape or the like obtained by replacing a part or a whole of a straight line in an outer peripheral profile of the typical shape by a curved line that can be considered as a substantially straight line, as well as in the case of cutting out the effective surface portion having the typical shape from the tempered glass sheet as described above.

The present invention has been made in view of the above-mentioned circumstances, and it is therefore a third technical object of the present invention to enable an effective surface portion having a substantially rectangular shape including a curved corner portion to be smoothly cut out when cutting out the effective surface portion from the tempered glass sheet.

### Solution to Problem

According to one embodiment of the present invention, which is devised to achieve the above-mentioned first technical object, there is provided a method of scribing a tempered glass sheet, which involves moving a rotary scribing blade along a preset cutting line having a closed-loop shape and serving as a boundary between an effective surface portion having an outer peripheral profile including a curved line and a non-effective surface portion surrounding the effective surface portion, to thereby form a scribe line for cutting the tempered glass sheet into the effective surface portion and the non-effective surface portion, the method comprising: forming a preparatory scribe line to be smoothly joined to the preset cutting line while being curved from the non-effective surface portion to the preset cutting line with use of the rotary scribing blade; and forming, after forming the preparatory scribe line, the scribe line that continues from the preparatory scribe line with use of the rotary scribing blade. The description “smoothly joined to the preset cutting line while being curved from the non-effective surface portion to the preset cutting line” herein encompasses the case where the preparatory scribe line is joined to the preset cutting line in a state of being in contact with the preset cutting line, and the case where an angle formed by a tangent of the preparatory scribe line and the preset cutting line is 10° or less at the point where the preparatory scribe line is joined to the preset cutting line or the case where an angle formed by the tangent of the preparatory scribe line and a tangent of the preset cutting line is 10° or less at the point where the preparatory scribe line is joined to the preset cutting line.

In the above-mentioned method, the preparatory scribe line is smoothly joined to the preset cutting line while being curved. Therefore, when the forming of the scribe line that continues from the preparatory scribe line is started, it is not necessary to abruptly change the moving direction of the rotary scribing blade. With this, even when a crack is generated in the vicinity of the point where the preparatory scribe line and the preset cutting line are joined to each other (hereinafter referred to as joining point), the crack is likely to be formed in a state of extending in parallel to the preset cutting line (scribe line after the forming of the scribe line is finished). As a result, even when the tempered glass sheet is cut along the crack, it is possible to suppress the generation of an uncut portion in the effective surface portion.

In the above-mentioned method, it is preferred that a starting end of the preparatory scribe line be positioned at an edge portion of the non-effective surface portion of the tempered glass sheet.

With this, along with the forming of the preparatory scribe line, a median crack to be formed in a thickness direction of the tempered glass sheet can be formed to have a depth suited to the operation of cutting over an entire length from the edge portion serving as the starting end of the preparatory scribe line to a terminal end thereof (starting end of the scribe line). Therefore, when the scribe line that continues from the preparatory scribe line is formed, a median crack can be similarly formed to have a depth suited to the operation of cutting the tempered glass sheet, and thus the tempered glass sheet can be cut easily.

In the above-mentioned method, it is preferred that a radius of curvature in the preparatory scribe line be 5 mm or more and 20 mm or less.

With this, when the radius of curvature is set to 5 mm or more, the abrupt change in the moving direction of the rotary scribing blade is avoided more suitably. Further, when the radius of curvature is set to 20 mm or less, the preparatory scribe line and the scribe line can be prevented from being formed in a state of being close to each other over a long distance. With this, it is possible to suitably avoid the occurrence of a situation where, when the tempered glass sheet is cut, a cut portion (cleaved portion) that is to be formed along the scribe line is formed along the preparatory scribe line or the cut portion (cleaved portion) is formed while alternately propagating between the scribe line and the preparatory scribe line.

In the above-mentioned method, when the preset cutting line includes a straight line, it is preferred that the preparatory scribe line be joined to the straight line of the preset cutting line. Further, when the preset cutting line includes only a curved line, it is preferred that the preparatory scribe line be joined to the preset cutting line at a position having a minimum curvature of the curved line in the preset cutting line.

With this, even when a crack is generated in the vicinity of the joining point, the crack is more likely to be formed in a state of extending in parallel to the preset cutting line.

In the above-mentioned method, it is preferred that the starting end of the preparatory scribe line be formed by moving the rotary scribing blade in a direction orthogonal to the edge portion.

With this, the rotary scribing blade is likely to be hooked onto the edge portion, which leads to a further advantage in forming the median crack to have a depth suited to the operation of cutting the tempered glass sheet in the preparatory scribe line.

In the above-mentioned method, it is preferred that the effective surface portion have a substantially rectangular shape including curved corner portions, and that the scribe line be formed so that a depth of the scribe line becomes larger at a curved part of the boundary between the effective surface portion and the non-effective surface portion along each of the curved corner portions than at other parts of the boundary between the effective surface portion and the non-effective surface portion. The “substantially rectangular shape including curved corner portions” herein encompasses not only the above-mentioned typical shape but also a shape obtained by replacing a part or a whole of a straight line in an outer peripheral profile of the typical shape by a curved line that can be considered as a substantially straight line.

With this, when the tempered glass sheet is cut by snapping after the forming of the scribe line in the tempered glass sheet is finished, at the curved part of the boundary between the effective surface portion and the non-effective surface portion (scribe line that has been formed) along the corner portion, the tempered glass sheet can be cut with smaller bending moment than at the other parts. With this, the effective surface portion and the non-effective surface portion can be separated more easily at the curved part than at the other parts, and hence the effective surface portion can be smoothly cut out from the tempered glass sheet.

In the above-mentioned method, it is preferred that a depth of the scribe line to be formed at the other parts of the boundary between the effective surface portion and the non-effective surface portion be set to 3 times or more of a thickness of a compressive stress layer formed on the tempered glass sheet, and to less than 60% of a thickness of the tempered glass sheet.

With this, at the other parts of the boundary between the effective surface portion and the non-effective surface portion, a crack (hereinafter referred to as “split crack”) generated from the scribe line (median crack included in the scribe line) is easily prevented from self-propagating in the thickness direction of the tempered glass sheet. On the other hand, at the curved part of the boundary between the effective surface portion and the non-effective surface portion along the corner portion, the scribe line is formed deeper than at the other parts, and hence the self-propagation of the split crack is likely to be induced. When the split crack self-propagates, the split crack propagates to the compressive stress layer on a tip end side in a propagation direction (thickness direction) due to the tensile stress applied to the tensile stress layer, with the result that a substantially entire thickness or an entire thickness of the tempered glass sheet is cut. Therefore, when the tempered glass sheet is cut by snapping after the forming of the scribe line is finished, the effective surface portion and the non-effective surface portion can be separated very easily at the curved part. As a result, the effective surface portion can be more smoothly cut out from the tempered glass sheet. Further, the split crack self-propagates and the substantially entire thickness or the entire thickness is cut at the curved part, whereas the other parts are in an uncut state in which only the scribe line is formed. Therefore, it is possible to prevent the occurrence of a situation where the effective surface portion and the non-effective surface portion are completely separated at an unintended timing, for example, while the tempered glass sheet is being conveyed, and the opposing cut surfaces rub against each other, thereby causing degradation in quality of the cut surfaces.

In the above-mentioned method, it is preferred that the scribe line be formed deeper at a part of the curved part along the corner portion, which has a small radius of curvature.

With this, the self-propagation of the split crack is likely to be induced at the curved part having a small radius of curvature, and the substantially entire thickness or the entire thickness of the tempered glass sheet is cut easily. Therefore, the effective surface portion and the non-effective surface portion can be separated more suitably at the curved part.

In the above-mentioned method, it is preferred that, when the scribe line is formed, at the curved part of the boundary between the effective surface portion and the non-effective surface portion along the corner portion, a pressing force of the rotary scribing blade for pressing the tempered glass sheet be set to be larger than that at the other parts.

With this, when the scribe line is formed, at the curved part of the boundary between the effective surface portion and the non-effective surface portion along the corner portion, the scribe line can be formed deeper than at the other parts.

In the above-mentioned method, it is preferred that, when the scribe line is formed, at the curved part of the boundary between the effective surface portion and the non-effective surface portion along the corner portion, a moving velocity of the rotary scribing blade be set to be lower than that at the other parts.

With this, the pressing force of the rotary scribing blade for pressing the tempered glass sheet can be more reliably applied to the curved part of the boundary between the effective surface portion and the non-effective surface portion along the corner portion than to the other parts. Therefore, the scribe line is easily formed deeper at the curved part, which in turn enables the split crack to self-propagate easily.

It is preferred that the above-mentioned method further comprise forming, by moving a scribing blade, an auxiliary scribe line extending toward the scribe line with the non-effective surface portion being a starting end of the auxiliary scribe line, and having a terminal end prevented from being joined to the scribe line.

With this, when the snapping is executed along the auxiliary scribe line after the forming of the scribe line and the auxiliary scribe line is finished and before the snapping is executed along the scribe line, the cut portion (cleaved portion) is accordingly formed along the auxiliary scribe line. In this case, the cut portion further propagates to the scribe line on the terminal end side of the auxiliary scribe line and propagates to the edge portion of the non-effective surface portion of the tempered glass sheet on the starting end side of the auxiliary scribe line. With this, the cut portion that continues from the scribe line to the edge portion is formed in the non-effective surface portion of the tempered glass sheet. In addition, the cut portion having reached the scribe line thereafter propagates along the scribe line. Due to the foregoing, when the snapping is executed along the scribe line after the execution of the snapping along the auxiliary scribe line, both side parts of the non-effective surface portion split by the cut portion can be bent separately and independently in each corresponding direction. Moreover, in a part in which the cut portion has already propagated along the scribe line, it is not necessary to bend the tempered glass sheet in a direction corresponding to the part. That is, it is not necessary to bend the tempered glass sheet simultaneously in various directions along with the execution of the snapping of the scribe line, and it is possible to limit the bending directions. As a result, the contact between the opposing cut surfaces of the effective surface portion and the non-effective surface portion can be suppressed to the extent possible. Further, when the auxiliary scribe line is formed, the terminal end of the auxiliary scribe line is not joined to the scribe line. Therefore, it is possible to avoid the occurrence of a situation where a crack generated from the auxiliary scribe line propagates to the effective surface portion due to the tensile stress applied to the tensile stress layer of the tempered glass sheet.

In the above-mentioned method, it is preferred that the starting end of the auxiliary scribe line be positioned at the edge portion of the non-effective surface portion of the tempered glass sheet.

With this, the auxiliary scribe line can be formed to have a depth suited to the operation of cutting by snapping over an entire length from the edge portion serving as the starting end of the auxiliary scribe line to the terminal end. Therefore, the snapping can be more reliably executed along the auxiliary scribe line.

In the above-mentioned method, it is preferred that the scribing blade be a rotary blade, and a separation distance between the terminal end of the auxiliary scribe line and the scribe line be set to 0.5 times or more and 3 times or less of a diameter of the rotary blade.

With this, when the auxiliary scribe line is formed, the propagation of the crack generated from the auxiliary scribe line to the effective surface portion can be avoided more suitably. Further, when the separation distance between the terminal end of the auxiliary scribe line and the scribe line is excessively long, during the execution of the snapping along the auxiliary scribe line, the cut portion may propagate in an unintended direction instead of propagating to the scribe line on the terminal end side of the auxiliary scribe line. However, when the separation distance is within the above-mentioned range, it is possible to suitably prevent the occurrence of such a situation.

In the above-mentioned method, it is preferred that a plurality of auxiliary scribe lines be formed.

As the number of the auxiliary scribe lines is larger, the non-effective surface portion is split in a larger number by the cut portions formed in the non-effective surface portion after the execution of the snapping along the auxiliary scribe line. Therefore, when the snapping is executed along the scribe line after the execution of the snapping along the auxiliary scribe line, the number of the bending directions can be further limited at a time of each bending of the non-effective surface portion split by the cut portions. As a result, when the plurality of auxiliary scribe lines are formed, the contact between the opposing cut surfaces of the effective surface portion and the non-effective surface portion can be suppressed more suitably when the snapping is executed along the scribe line. Further, when the non-effective surface portion is removed after the execution of the snapping along the scribe line, each of the cut surfaces of the non-effective surface portion that has been split in a large number and the cut surface of the effective surface portion can also be separated away from each other easily without being brought into contact with each other. With this, when the non-effective surface portion is removed, it is also possible to suitably suppress the contact between the cut surfaces.

In the above-mentioned method, it is preferred that the scribe line include a linear part extending linearly, and that the auxiliary scribe line be formed toward the linear part of the scribe line.

With this, when the tempered glass sheet is cut along the scribe line, the generation of an uncut portion of the effective surface portion can be avoided suitably.

In the above-mentioned method, it is preferred that the auxiliary scribe line be formed linearly and be formed along a direction perpendicular to the scribe line.

With this, when the tempered glass sheet is cut along the scribe line, there is a further advantage in avoiding the generation of the uncut portion in the effective surface portion.

In the above-mentioned method, it is preferred that a point at which the preparatory scribe line is joined to the preset cutting line and a terminal end of the scribe line be separated away from each other.

With this, when the terminal end of the scribe line is formed, there is no risk in that the crack extending in a direction different from that of the scribe line is generated in the vicinity of the joining point. Therefore, it is possible to more suitably suppress the generation of the uncut portion in the effective surface portion.

Further, according to one embodiment of the present invention, which is devised to achieve the above-mentioned second technical object, there is provided a method of scribing a tempered glass sheet, which involves moving a scribing blade along a preset cutting line having a closed-loop shape and serving as a boundary between an effective surface portion having an outer peripheral profile including a curved line and a non-effective surface portion surrounding the effective surface portion, to thereby form a scribe line for cutting the tempered glass sheet into the effective surface portion and the non-effective surface portion, the method comprising forming, by moving the scribing blade, an auxiliary scribe line extending toward the scribe line with the non-effective surface portion being a starting end of the auxiliary scribe line, and having a terminal end prevented from being joined to the scribe line.

In the above-mentioned method, when the snapping is executed along the auxiliary scribe line after the forming of the scribe line and the auxiliary scribe line is finished and before the snapping is executed along the scribe line, the cut portion (cleaved portion) is accordingly formed along the auxiliary scribe line. In this case, the cut portion further propagates to the scribe line on the terminal end side of the auxiliary scribe line and propagates to the edge portion of the non-effective surface portion of the tempered glass sheet on the starting end side of the auxiliary scribe line. With this, the cut portion that continues from the scribe line to the edge portion is formed in the non-effective surface portion of the tempered glass sheet. In addition, the cut portion having reached the scribe line thereafter propagates along the scribe line. Due to the foregoing, when the snapping is executed along the scribe line after the execution of the snapping along the auxiliary scribe line, both side parts of the non-effective surface portion split by the cut portion can be bent separately and independently in each corresponding direction. Moreover, in a part in which the cut portion has already propagated along the scribe line, it is not necessary to bend the tempered glass sheet in a direction corresponding to the part. That is, it is not necessary to bend the tempered glass sheet simultaneously in various directions along with the execution of the snapping of the scribe line, and it is possible to limit the bending directions. As a result, the contact between the opposing cut surfaces of the effective surface portion and the non-effective surface portion can be suppressed to the extent possible. Further, when the auxiliary scribe line is formed, the terminal end of the auxiliary scribe line is not joined to the scribe line. Therefore, it is possible to avoid the occurrence of a situation where a crack generated from the auxiliary scribe line propagates to the effective surface portion due to the tensile stress applied to the tensile stress layer of the tempered glass sheet.

In the above-mentioned method, it is preferred that the starting end of the auxiliary scribe line be positioned at the edge portion of the non-effective surface portion of the tempered glass sheet.

With this, the actions and effects similar to those of the above description of the embodiment corresponding to the method of scribing a tempered glass sheet can be obtained.

In the above-mentioned method, it is preferred that the scribing blade be a rotary blade, and a separation distance between the terminal end of the auxiliary scribe line and the scribe line be set to 0.5 times or more and 3 times or less of a diameter of the rotary blade.

With this, the actions and effects similar to those of the above description of the embodiment corresponding to the method of scribing a tempered glass sheet can be obtained.

In the above-mentioned method, it is preferred that a plurality of auxiliary scribe lines be formed.

With this, the actions and effects similar to those of the above description of the embodiment corresponding to the method of scribing a tempered glass sheet can be obtained.

In the above-mentioned method, it is preferred that the scribe line include a linear part extending linearly, and that the auxiliary scribe line be formed toward the linear part of the scribe line.

With this, the actions and effects similar to those of the above description of the embodiment corresponding to the method of scribing a tempered glass sheet can be obtained.

In the above-mentioned method, it is preferred that the auxiliary scribe line be formed linearly and be formed along a direction perpendicular to the scribe line.

With this, the actions and effects similar to those of the above description of the embodiment corresponding to the method of scribing a tempered glass sheet can be obtained.

In the above-mentioned method, it is preferred that the effective surface portion have a substantially rectangular shape including curved corner portions, and that the scribe line be formed so that a depth of the scribe line becomes larger at a curved part of the boundary between the effective surface portion and the non-effective surface portion along each of the curved corner portions than at other parts of the boundary between the effective surface portion and the non-effective surface portion.

With this, the actions and effects similar to those of the above description of the embodiment corresponding to the method of scribing a tempered glass sheet can be obtained.

In the above-mentioned method, it is preferred that the depth of the scribe line to be formed at the other parts of the boundary between the effective surface portion and the non-effective surface portion be set to 3 times or more of the thickness of the compressive stress layer formed on the tempered glass sheet, and to less than 60% of the thickness of the tempered glass sheet.

With this, the actions and effects similar to those of the above description of the embodiment corresponding to the method of scribing a tempered glass sheet can be obtained.

In the above-mentioned method, it is preferred that the scribe line be formed deeper at a part of the curved part along the corner portion, which has a small radius of curvature.

With this, the actions and effects similar to those of the above description of the embodiment corresponding to the method of scribing a tempered glass sheet can be obtained.

In the above-mentioned method, it is preferred that, when the scribe line is formed, at the curved part of the boundary between the effective surface portion and the non-effective surface portion along the corner portion, the pressing force of the scribing blade for pressing the tempered glass sheet be set to be larger than that at the other parts.

With this, the actions and effects similar to those of the above description of the embodiment corresponding to the method of scribing a tempered glass sheet can be obtained.

In the above-mentioned method, it is preferred that, when the scribe line is formed, at the curved part of the boundary between the effective surface portion and the non-effective surface portion along the corner portion, the moving velocity of the scribing blade be set to be lower than that at the other parts.

With this, the actions and effects similar to those of the above description of the embodiment corresponding to the method of scribing a tempered glass sheet can be obtained.

Further, according to one embodiment of the present invention, which is devised to achieve the above-mentioned third technical object, there is provided a method of scribing a tempered glass sheet, which involves moving a scribing blade along a boundary between an effective surface portion having a substantially rectangular shape including curved corner portions and a non-effective surface portion surrounding the effective surface portion, to thereby form a scribe line for cutting the tempered glass sheet into the effective surface portion and the non-effective surface portion, the method comprising forming the scribe line so that a depth of the scribe line becomes larger at a curved part of the boundary between the effective surface portion and the non-effective surface portion along each of the curved corner portions than at other parts of the boundary between the effective surface portion and the non-effective surface portion. The description “substantially rectangular shape including curved corner portions” herein encompasses not only the above-mentioned typical shape but also a shape obtained by replacing a part or a whole of a straight line in an outer peripheral profile of the typical shape by a curved line that can be considered as a substantially straight line.

In the above-mentioned method, when the tempered glass sheet is cut by snapping after the forming of the scribe line in the tempered glass sheet is finished, at the curved part of the boundary between the effective surface portion and the non-effective surface portion (scribe line that has been formed) along the corner portion, the tempered glass sheet can be cut with smaller bending moment than at the other parts. With this, the effective surface portion and the non-effective surface portion can be separated more easily at the curved part than at the other parts, and hence the effective surface portion can be smoothly cut out from the tempered glass sheet.

In the above-mentioned method, it is preferred that the depth of the scribe line to be formed at the other parts of the boundary between the effective surface portion and the non-effective surface portion be set to 3 times or more of the thickness of the compressive stress layer formed on the tempered glass sheet, and to less than 60% of the thickness of the tempered glass sheet.

With this, the actions and effects similar to those of the above description of the embodiment corresponding to the method of scribing a tempered glass sheet can be obtained.

In the above-mentioned method, it is preferred that the scribe line be formed deeper at a part of the curved part along the corner portion, which has a small radius of curvature.

With this, the actions and effects similar to those of the above description of the embodiment corresponding to the method of scribing a tempered glass sheet can be obtained.

In the above-mentioned method, it is preferred that, when the scribe line is formed, at the curved part of the boundary between the effective surface portion and the non-effective surface portion along the corner portion, the pressing force of the scribing blade for pressing the tempered glass sheet be set to be larger than that at the other parts.

With this, the actions and effects similar to those of the above description of the embodiment corresponding to the method of scribing a tempered glass sheet can be obtained.

In the above-mentioned method, it is preferred that, when the scribe line is formed, at the curved part of the boundary between the effective surface portion and the non-effective surface portion along the corner portion, the moving velocity of the scribing blade be set to be lower than that at the other parts.

With this, the actions and effects similar to those of the above description of the embodiment corresponding to the method of scribing a tempered glass sheet can be obtained.

### Advantageous Effects of Invention

As described above, according to the one embodiment of the present invention, when the effective surface portion having an outer peripheral profile including a curved line is cut out from the tempered glass sheet, it is possible to suppress the generation of an uncut portion in the effective surface portion. Further, it is possible to suppress the contact between the opposing cut surfaces of the effective surface portion and the non-effective surface portion to the extent possible. Further, it is possible to smoothly cut out the effective surface portion.

### BRIEF DESCRIPTION OF DRAWINGS

FIG. 1 is a plan view for illustrating a tempered glass sheet for which a method of scribing a tempered glass sheet according to a first embodiment of the present invention is carried out.

FIG. 2 is a view for illustrating a compressive stress layer and a tensile stress layer formed on the tempered glass sheet for which the method of scribing a tempered glass sheet according to the first embodiment of the present invention is carried out.

FIG. 3a is a plan view for illustrating the method of scribing a tempered glass sheet according to the first embodiment of the present invention.

FIG. 3b is an enlarged view of a vicinity of a preparatory scribe line of FIG. 3a.

FIG. 4a is a plan view for illustrating the method of scribing a tempered glass sheet according to the first embodiment of the present invention.

FIG. 4b is an enlarged view of a vicinity of a joining point of FIG. 4a.

FIG. 5a is a view for illustrating how a scribe line is formed.

FIG. 5b is a view for illustrating how the scribe line is formed.

FIG. 5c is a view for illustrating how the scribe line is formed.

FIG. 6 is a plan view for illustrating how an auxiliary scribe line is formed in the method of scribing a tempered glass sheet according to the first embodiment of the present invention.

FIG. 7 is a plan view for illustrating how the auxiliary scribe line is formed in the method of scribing a tempered glass sheet according to the first embodiment of the present invention.

FIG. 8a is a view for illustrating a median crack formed in the tempered glass sheet.

FIG. 8b is a view for illustrating the median crack formed in the tempered glass sheet.

FIG. 8c is a view for illustrating the median crack formed in the tempered glass sheet.

FIG. 9 is a plan view for illustrating an action of the method of scribing a tempered glass sheet according to the first embodiment of the present invention.

FIG. 10 is a plan view for illustrating an action of the method of scribing a tempered glass sheet according to the first embodiment of the present invention.

FIG. 11 is a plan view for illustrating an action of the method of scribing a tempered glass sheet according to the first embodiment of the present invention.

FIG. 12 is a plan view for illustrating an action of the method of scribing a tempered glass sheet according to the first embodiment of the present invention.

FIG. 13 is an enlarged view of a vicinity of a preparatory scribe line in a method of scribing a tempered glass sheet according to a second embodiment of the present invention.

FIG. 14 is an enlarged view of a vicinity of a preparatory scribe line in a method of scribing a tempered glass sheet according to a third embodiment of the present invention.

FIG. 15 is an enlarged view of a vicinity of a preparatory scribe line in a method of scribing a tempered glass sheet according to a fourth embodiment of the present invention.

FIG. 16 is an enlarged view of a vicinity of a preparatory scribe line in a method of scribing a tempered glass sheet according to a fifth embodiment of the present invention.

FIG. 17 is a plan view for illustrating a tempered glass sheet for which a method of scribing a tempered glass sheet according to a sixth embodiment of the present invention is carried out.

FIG. 18 is a plan view for illustrating a method of scribing a tempered glass sheet according to a seventh embodiment of the present invention.

FIG. 19 is a plan view for illustrating a method of scribing a tempered glass sheet according to an eighth embodiment of the present invention.

FIG. 20 is a plan view for illustrating a method of scribing a tempered glass sheet according to a ninth embodiment of the present invention.

FIG. 21 is a plan view for illustrating a method of scribing a tempered glass sheet according to a tenth embodiment of the present invention.

FIG. 22 is a plan view for illustrating a method of scribing a tempered glass sheet according to a comparative example.

FIG. 23 is a plan view for illustrating a tempered glass sheet.

FIG. 24 is a plan view for illustrating a method of scribing a tempered glass sheet in the related art.

FIG. 25 is an enlarged view of a vicinity of a joining point in the method of scribing a tempered glass sheet in the related art.

FIG. 26 is an enlarged view of an effective surface portion of a cut tempered glass sheet after being subjected to the method of scribing a tempered glass sheet in the related art.

### DESCRIPTION OF EMBODIMENTS

Now, embodiments of the present invention are described with reference to the accompanying drawings. Note that, in a method of scribing a tempered glass sheet according to each of the embodiments to be described below, the tempered glass sheet for which the method is carried out is only one structural example, and as described later, the method of scribing a tempered glass sheet according to the present invention is not intended for the tempered glass sheet alone.

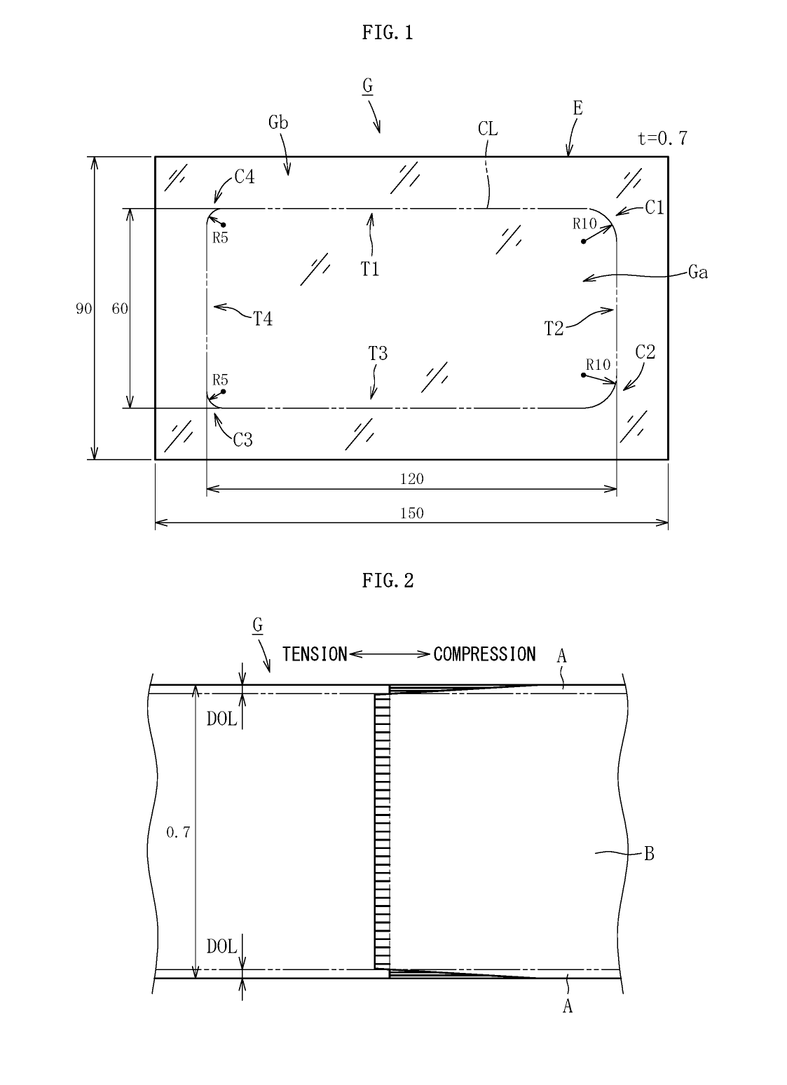

FIG. 1 is a plan view for illustrating a tempered glass sheet G for which a method of scribing a tempered glass sheet according to a first embodiment of the present invention is carried out, and FIG. 2 is a view for illustrating a compressive stress layer A and a tensile stress layer B formed on the tempered glass sheet G. As illustrated in FIG. 1 and FIG. 2, the tempered glass sheet G has a rectangular shape. Further, the compressive stress layers A having compressive stress applied thereto are formed on a front surface side and a back surface side of the tempered glass sheet G in its thickness direction, and the tensile stress layer B having tensile stress applied thereto is formed between both the compressive stress layers A.

In this case, in this embodiment, a magnitude of the compressive stress applied to each of both the compressive stress layers A is 710 MPa, and a thickness DOL of each of both the compressive stress layers A is 20.8 μm. Further, a magnitude of the tensile stress applied to the tensile stress layer B is 21.4 MPa. Further, the tempered glass sheet G has dimensions of 150 mm wide, 90 mm long, and 0.7 mm high. Note that, in FIG. 2, the thickness DOL of the compressive stress layer A occupying the thickness of the tempered glass sheet G is illustrated in an enlarged state as compared to an actual ratio.

Herein, the tempered glass sheet G (original glass sheet to be processed into the tempered glass sheet G) preferably has a composition containing, as a glass composition, in terms of mass %, 50% to 80% of SiO₂, 5% to 25% of Al₂O₃, 0% to 15% of B₂O₃, 1% to 20% of Na₂O, and 0% to 10% of K₂O. With this composition, a tempered glass sheet G excellent in both ion exchange performance and devitrification resistance can be obtained.

Further, the tempered glass sheet G is formed of an effective surface portion Ga that is to be cut out and has a typical shape and a non-effective surface portion Gb that surrounds the effective surface portion Ga and is to be discarded after cutting of the tempered glass sheet G. Then, a preset cutting line CL having a closed-loop shape serves as a boundary between the effective surface portion Ga and the non-effective surface portion Gb. That is, in this embodiment, the typical shape is to be cut out as the effective surface portion Ga having an outer peripheral profile including a curved line.

The effective surface portion Ga has dimensions of 120 mm wide, 60 mm long, and 0.7 mm high. Further, the preset cutting line CL (scribe line S after the forming of the scribe line S (described later) is finished) serving as the boundary between the effective surface portion Ga and the non-effective surface portion Gb includes curved parts C1 to C4 along respective corner portions at four positions in the effective surface portion Ga and linear parts T1 to T4 at four positions connecting the curved parts C1 to C4 to each other. Herein, the radius of curvature of each of the curved parts C1 to C4 is set to 10 mm in C1 and C2 and 5 mm in C3 and C4. That is, the radius of curvature of C3 and C4 is smaller than that of C1 and C2. Herein, in this embodiment, the other parts of the boundary between the effective surface portion Ga and the non-effective surface portion Gb are formed of the linear parts T1 to T4.

Now, a method of scribing a tempered glass sheet according to the first embodiment of the present invention is described with reference to the accompanying drawings. Note that, in this embodiment and the other embodiments to be described thereafter, a scribing wheel H is used as a rotary scribing blade (scribing blade) for forming a preparatory scribe line RS, the scribe line S, and an auxiliary scribe line HS.

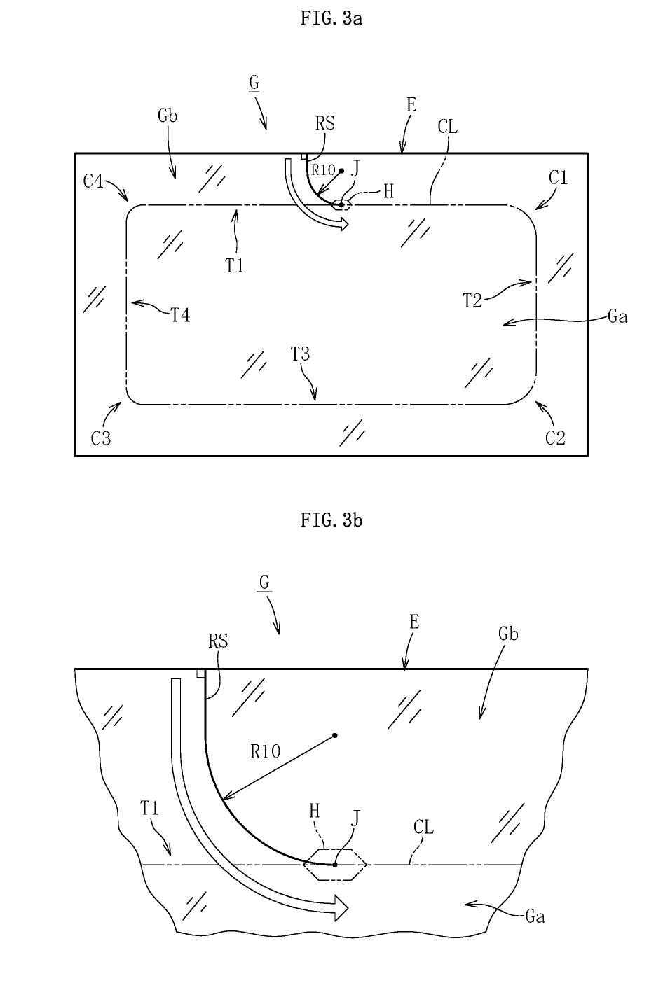

First, as indicated by the blank arrow in FIG. 3a and FIG. 3b, the forming of the preparatory scribe line RS is started from the non-effective surface portion Gb, with an edge portion E of the tempered glass sheet G being a starting end. The starting end of the preparatory scribe line RS is formed by hooking the scribing wheel H onto the edge portion E and moving the scribing wheel H in a direction orthogonal to the edge portion E.

Next, the preparatory scribe line RS is brought close to the preset cutting line CL while the moving direction of the scribing wheel H is changed gradually. Then, the preparatory scribe line RS is smoothly joined to the preset cutting line CL while being curved so that the preparatory scribe line RS and the preset cutting line CL are brought into contact with each other at a joining point J positioned on the linear part T1. With this, the forming of the preparatory scribe line RS is finished.

Herein, the radius of curvature of the preparatory scribe line RS is set to 5 mm or more and 20 mm or less. In this embodiment, the radius of curvature of the preparatory scribe line RS is set to 10 mm. Further, in this embodiment, the moving velocity of the scribing wheel H when forming the preparatory scribe line RS is set to 15 mm/s, and a pressing force of the scribing wheel H for pressing a surface of the tempered glass sheet G is set to 9.4 N. Further, in this embodiment, the preparatory scribe line RS includes both of a linear part in the vicinity of the starting end and a curved part in the vicinity of a terminal end. Further, the curved part in the vicinity of the terminal end is curved with a predetermined radius of curvature.

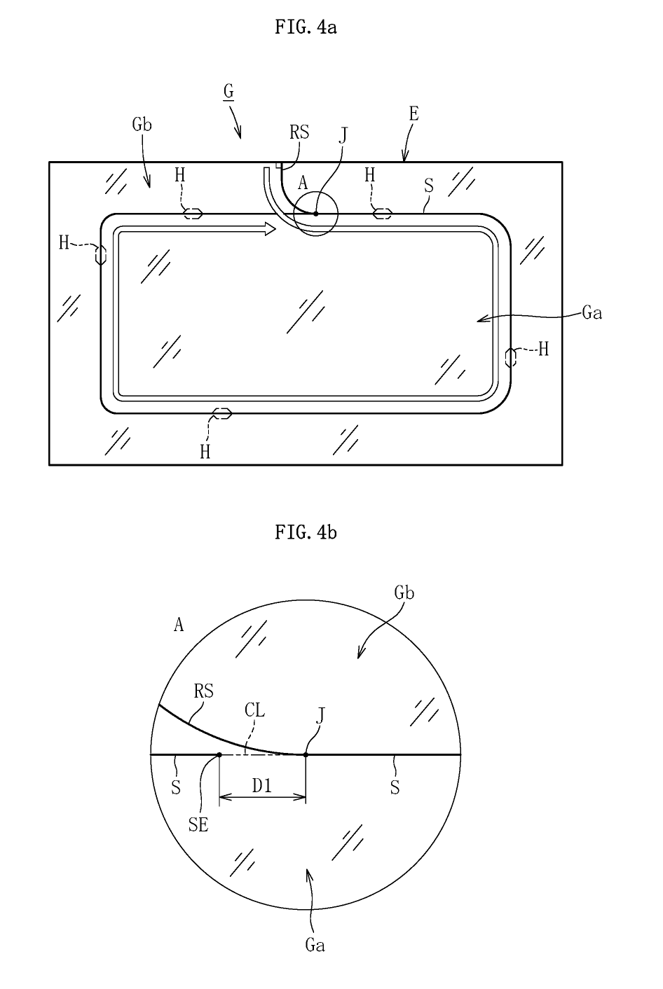

When the forming of the preparatory scribe line RS is finished, as indicated by the blank arrow in FIG. 4a, the forming of the scribe line S, which continues from the preparatory scribe line RS, for cutting the tempered glass sheet G into the effective surface portion Ga and the non-effective portion Gb is started by moving the scribing wheel H along the preset cutting line CL. That is, the terminal end (joining point J) of the preparatory scribe line RS serves as a starting end for starting the forming of the scribe line S.

Then, the scribe line S having a closed-loop shape is formed, with the joining point J being the starting end of the scribe line S. At this time, as illustrated in FIG. 4b, the scribe line S is formed so that a terminal end SE of the scribe line S and the joining point J are separated away from each other. Note that, it is preferred that a separation distance D1 between the joining point J and the terminal end SE of the scribe line S be set to from 0.05 mm to 1 mm.

Now, detailed description is given of how the scribe line S having a closed-loop shape is formed. Note that, how the scribe line S is formed at the respective linear parts T1 to T4 of the preset cutting line CL is entirely the same, and hence description is given of only how the scribe line S is formed at the linear part T1 as a representative example. Further, how the scribe line S is formed is the same in C1 and C2 among the respective curved parts C1 to C4, and similarly, how the scribe line S is formed is the same in C3 and C4. Therefore, as representative examples, description is given of only how the scribe line S is formed at C1 and how the scribe line S is formed at C3.

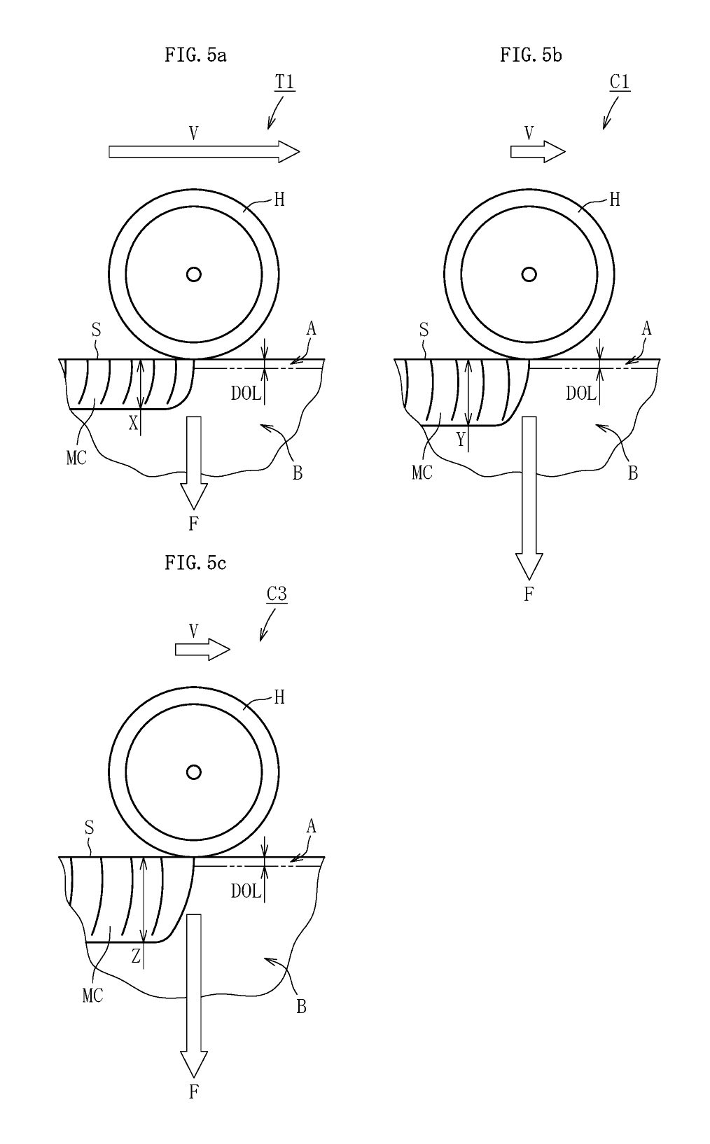

FIG. 5a to FIG. 5c are views for illustrating how the scribing wheel H moves on the linear part T1 (T2, T3, T4), the curved part C1 (C2), and the curved part C3 (C4) of the preset cutting line CL, respectively. As illustrated in FIG. 5a to FIG. 5c, moving velocities V of the scribing wheel H on the curved parts C1 and C3 of the preset cutting line CL are the same and set to be lower than the moving velocity V at which the scribing wheel H moves on the linear part T1. Further, pressing forces F of the scribing wheel H for pressing the tempered glass sheet G when the scribing wheel H moves on the curved parts C1 and C3 are the same and set to be larger than the pressing force F of the scribing wheel H for pressing the tempered glass sheet G when the scribing wheel H moves on the linear part T1.

Note that, in this embodiment, the moving velocity V of the scribing wheel H when forming the scribe line S is set to 100 mm/s on the linear parts T1 to T4 of the preset cutting line CL and 20 mm/s on the curved parts C1 to C4 of the preset cutting line CL. Further, the pressing force F of the scribing wheel H for pressing the surface of the tempered glass sheet G is set to 8.5 N on the linear parts T1 to T4 and 9.4 N on the curved parts C1 to C4.

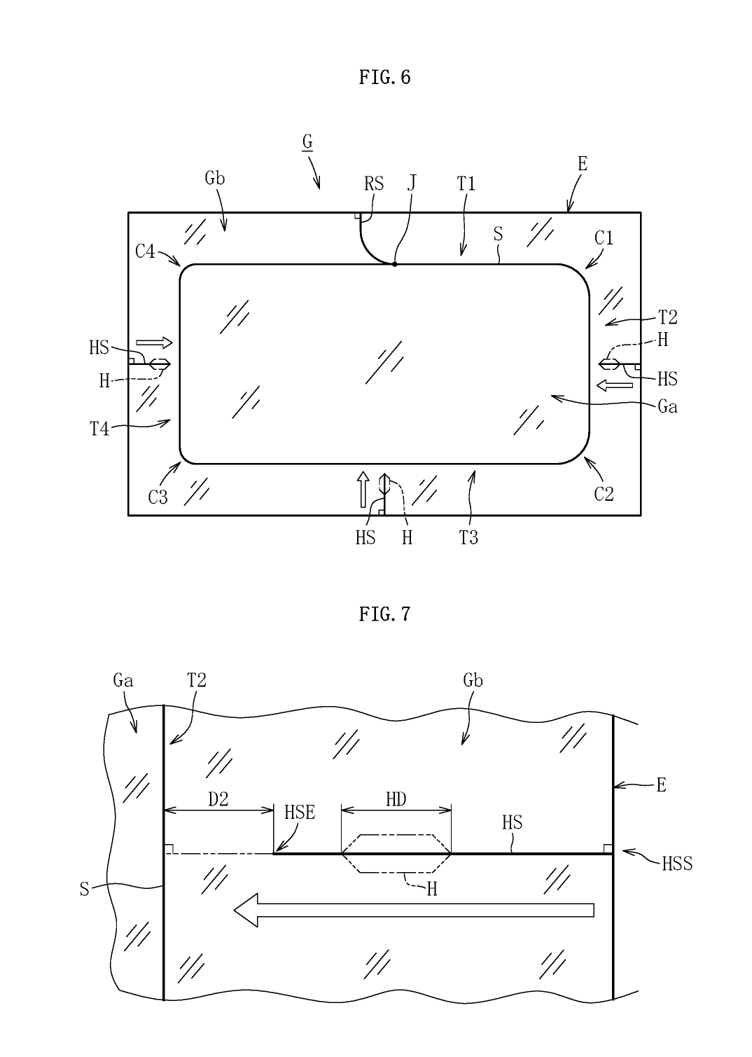

When the forming of the scribe line S is finished, as illustrated in FIG. 6, the auxiliary scribe lines HS (three in this embodiment) are formed by the scribing wheel H from the edge portion E of the non-effective surface portion Gb of the tempered glass sheet G toward each of the linear parts T2 to T4 of the scribe line S that has been formed. Herein, how the auxiliary scribe lines HS are formed toward the respective linear parts T2 to T4 is entirely the same, and hence description is given of only how the auxiliary scribe line HS is formed toward the linear part T2 as a representative example.

As illustrated in FIG. 7, the forming of the auxiliary scribe line HS is started by hooking the scribing wheel H onto the edge portion E and moving the scribing wheel H in the direction orthogonal to the edge portion E. Then, the auxiliary scribe line HS is formed so that an entire length from a starting end HSS positioned at the edge portion E to a terminal end HSE extends linearly, and the forming of the auxiliary scribe line HS is finished so that the terminal end HSE is not joined to the linear part T2. In this case, as illustrated in FIG. 7, a separation distance D2 between the terminal end HSE of the auxiliary scribe line HS and the linear part T2 of the scribe line S is set to 0.5 times or more and 3 times or less of a diameter HD of the scribing wheel H. Further, the auxiliary scribe line HS is formed in a direction perpendicular to the linear part T2.

Note that, in this embodiment, the moving velocity of the scribing wheel H when forming the auxiliary scribe line HS toward each of the linear parts T2 to T4 is set to 15 mm/s, and the pressing force of the scribing wheel H for pressing the surface of the tempered glass sheet G is set to 10 N. Further, the diameter HD of the scribing wheel H is 2 mm, and the separation distance D2 between the terminal end HSE of the auxiliary scribe line HS and the linear part T2 of the scribe line S is set to 2 mm.

Now, actions and effects of the method of scribing a tempered glass sheet according to the first embodiment of the present invention are described.

In the method of scribing a tempered glass sheet according to the first embodiment, the preparatory scribe line RS is smoothly joined to the linear part T1 of the preset cutting line CL while being curved, and the radius of curvature (=10 mm) thereof is set to 5 mm or more. Therefore, when the forming of the scribe line S that continues from the preparatory scribe line RS is started, an abrupt change in the moving direction of the scribing wheel H can be avoided suitably.

With this, even when a crack is generated in the vicinity of the joining point J, the crack is likely to be formed in a state of extending in parallel to the preset cutting line CL (scribe line S). As a result, even when the tempered glass sheet G is cut (cleaved) along the crack during cutting the tempered glass sheet by snapping, it is possible to suppress the generation of an uncut portion of the effective surface portion Ga.

Further, the radius of curvature (=10 mm) of the preparatory scribe line RS is 20 mm or less, and hence the preparatory scribe line RS and the scribe line S can be prevented from being formed in a state of being close to each other over a long distance. With this, it is possible to suitably prevent the occurrence of a situation where, when the tempered glass sheet G is cut, a cut portion (cleaved portion) that is to be formed along the scribe line S is formed along the preparatory scribe line RS or the cut portion (cleaved portion) is formed while alternately propagating between the scribe line S and the preparatory scribe line RS.

Further, the starting end of the preparatory scribe line RS is positioned at the edge portion E of the tempered glass sheet G, and hence a median crack to be formed in a thickness direction of the tempered glass sheet G along with the forming of the preparatory scribe line RS can be formed to have a depth suited to the operation of cutting over an entire length from the edge portion E serving as the starting end of the preparatory scribe line RS to the joining point J serving as the terminal end thereof.

Therefore, when the scribe line S that continues from the preparatory scribe line RS is formed, a median crack MC can be similarly formed to have a depth suited to the operation of cutting the tempered glass sheet G, and thus the tempered glass sheet G can be cut easily. In addition, the starting end of the preparatory scribe line RS is formed by moving the scribing wheel H in the direction orthogonal to the edge portion E, and hence the scribing wheel H is easily hooked onto the edge portion E, which leads to a further advantage in forming the median crack MC to have a depth suited to the operation of cutting.

Further, the terminal end SE of the scribe line S and the joining point J are separated away from each other, and hence there is no risk in that a crack extending in a direction different from the scribe line S may be generated in the vicinity of the joining point J when the terminal end SE of the scribe line S is formed. Therefore, the effect of suppressing the generation of the uncut portion of the effective surface portion Ga can be further increased.

Further, in the method of scribing a tempered glass sheet according to the first embodiment, as illustrated in FIG. 5a to FIG. 5c, at the curved parts C1 and C3 of the boundary between the effective surface portion Ga and the non-effective surface portion Gb (scribe line S that has been formed), the median crack MC, which is included in the scribe line S and extends in the thickness direction of the tempered glass sheet G, is formed deeper than at the linear part T1. Note that, a depth X of the median crack MC to be formed at the linear part T1 is 3 times or more of the thickness DOL of the compressive stress layer A formed on the tempered glass sheet G and less than 60% of the thickness of the tempered glass sheet G.

Note that, as described above, the median crack MC can be formed deeper at the curved parts C1 and C3 than at the linear part T1 for the following reasons. As illustrated in FIG. 5a to FIG. 5c, (1) the pressing force F of the scribing wheel H for pressing the tempered glass sheet G when forming the scribe line S is set to be larger at the curved parts C1 and C3 along the corner portions than at the linear part T1, and (2) the pressing force F can be reliably applied by setting the moving velocity V at which the scribing wheel H moves on the curved parts C1 and C3 to be lower than the moving velocity V at which the scribing wheel H moves on the linear part T1.

With this, at the curved parts C1 to C4 along the corner portions of the boundary between the effective surface portion Ga and the non-effective surface portion Gb, it is possible to cut the tempered glass sheet G by snapping with smaller bending moment than at the linear parts T1 to T4. With this, the effective surface portion Ga and the non-effective surface portion Gb are separated more easily at the curved parts C1 to C4 than at the linear parts T1 to T4. Therefore, it is possible to smoothly cut out the effective surface portion Ga from the tempered glass sheet G.

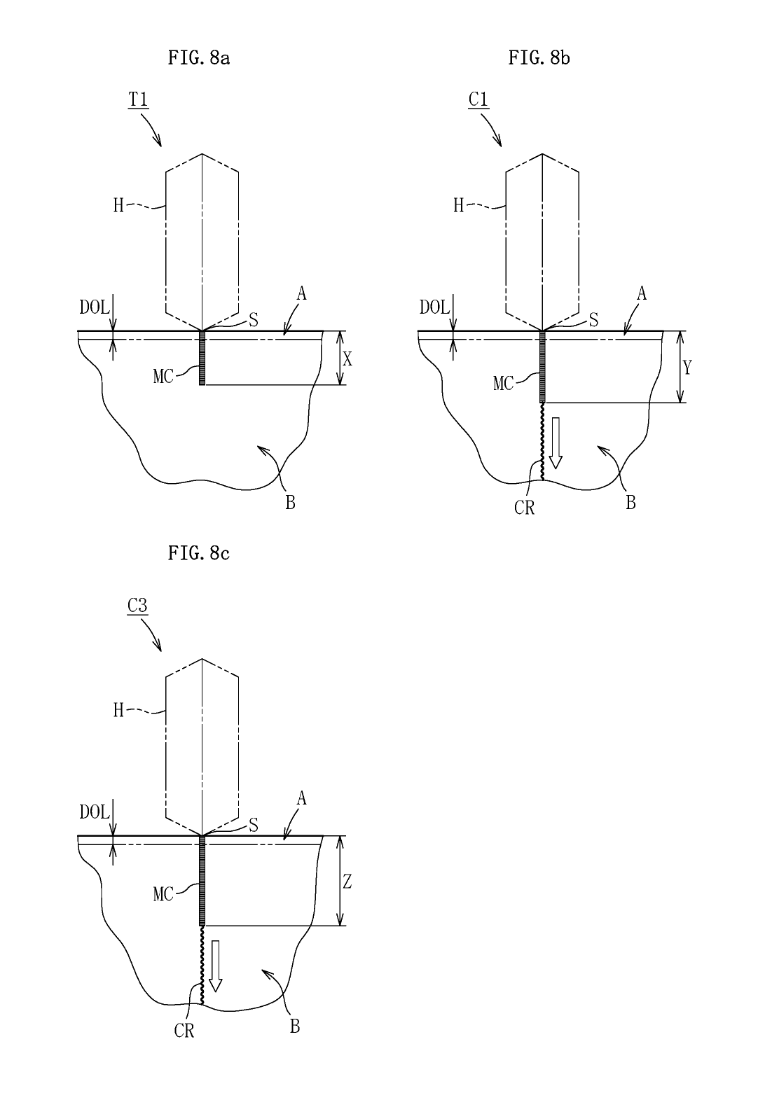

FIG. 8a to FIG. 8c are views for illustrating the median crack MC formed at the linear part T1 (T2, T3, T4), the curved part C1 (C2), and the curved part C3 (C4) of the boundary between the effective surface portion Ga and the non-effective surface portion Gb. As illustrated in FIG. 8a, at the linear part T1, it is easy to avoid the occurrence of a situation where a split crack CR generated from the median crack MC self-propagates in the thickness direction of the tempered glass sheet G when the scribe line S is formed. On the other hand, the curved parts C1 and C3 along the corner portions are pressed more strongly with the scribing wheel H than the linear part T1, and the median crack MC is formed deeper at the curved parts C1 and C3 than at the linear part T1. Therefore, as indicated by the blank arrow in FIG. 8b and FIG. 8c, the self-propagation of the split crack CR is likely to be induced.

When the self-propagation of the split crack CR occurs, the split crack CR propagates to the compressive stress layer A on a tip end side in the propagation direction (thickness direction) due to the tensile stress applied to the tensile stress layer B, with the result that a substantially entire thickness or an entire thickness of the tempered glass sheet G is cut. Therefore, when the tempered glass sheet G is cut by snapping after the forming of the scribe line S is finished, the effective surface portion Ga and the non-effective surface portion Gb can be separated more easily at the curved parts C1 to C4.

As a result, the effective surface portion Ga can be more smoothly cut out from the tempered glass sheet G. Further, the split crack CR self-propagates and the substantially entire thickness or the entire thickness is cut at the curved parts C1 to C4, whereas the linear parts T1 to T4 are in an uncut state in which only the median crack MC is formed. Therefore, it is possible to prevent the occurrence of a situation where the effective surface portion Ga and the non-effective surface portion Gb are completely separated at an unintended timing, for example, while the tempered glass sheet G is being conveyed, and the opposing cut surfaces rub against each other, thereby causing degradation in quality of the cut surfaces.

Further, in the method of scribing a tempered glass sheet according to the first embodiment, the median crack MC can be formed deeper at the curved parts C3 and C4 having a relatively small radius of curvature (=5 mm) than at the curved parts C1 and C2 having a relatively large radius of curvature (=10 mm). Due to the foregoing, the self-propagation of the split crack CR is likely to be induced at the curved parts C3 and C4 than at the curved parts C1 and C2. Therefore, the curved parts C3 and C4 are further likely to be in a state in which the substantially entire thickness or the entire thickness of the tempered glass sheet G is cut, and the effective surface portion Ga and the non-effective surface portion Gb can be separated suitably at the curved parts C1 to C4.

Note that, in this embodiment, the depths (depths represented by reference symbols X, Y, and Z in FIG. 5a to FIG. 5c and FIG. 8a to FIG. 8c) of the median crack MC formed at the linear part T1 (T2, T3, T4), the curved part C1 (C2), and the curved part C3 (C4) of the boundary between the effective surface portion Ga and the non-effective surface portion Gb were linear part T1 (T2, T3, T4): X=120 μm, curved part C1 (C2): Y=130 μm, and curved part C3 (C4): Z=150 μm (measured after cutting of the tempered glass sheet G).

Herein, the condition for setting the depth X of the median crack MC to be formed at the linear parts T1 to T4 to be 3 times or more of the thickness DOL of the compressive stress layer A formed on the tempered glass sheet G and less than 60% of the thickness of the tempered glass sheet G vary depending on (1) the thickness DOL of the compressive stress layer A, (2) the magnitude of the compressive stress applied to the compressive stress layer A, (3) the thickness of the tensile stress layer B, and (4) the magnitude of the tensile stress applied to the tensile stress layer B. Therefore, when the conditions of (1) to (4) are changed, the moving velocity V of the scribing wheel H, the pressing force F of the scribing wheel H for pressing the tempered glass sheet G, and the like are set appropriately. For example, optimum setting can be found out by performing trial cutting while changing the moving velocity V and the pressing force F.

Further, the condition for forming the median crack MC deeper at the curved parts C1 to C4 than at the linear parts T1 to T4 is that the pressing force F of the scribing wheel H for pressing the tempered glass sheet G is set to be larger at the curved parts C1 to C4 than at the linear parts T1 to T4. Note that, the magnitude of the pressing force F is increased preferably by 5% or more, more preferably 10% or more at the curved parts C1 to C4 than at the linear parts T1 to T4. Further, the moving velocity V of the scribing wheel H at the curved parts C1 to C4 is set to be preferably 60% or less, more preferably 40% or less of that at the linear parts T1 to T4.

Further, at the curved parts C1 to C4, even when the magnitude of the pressing force F and the moving velocity V are respectively identical, the median crack MC is naturally formed deeper at the curved parts C3 and C4 having a relatively small radius of curvature than at the curved parts C1 and C2 having a relatively large radius of curvature.

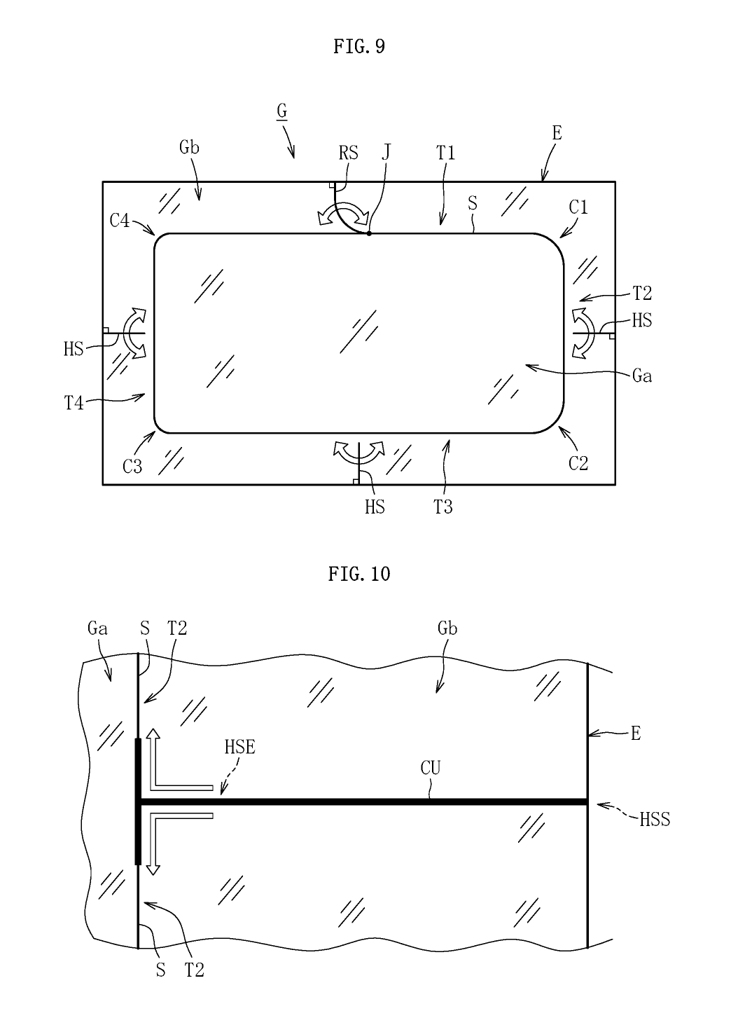

Further, in the method of scribing a tempered glass sheet according to the first embodiment, before the snapping is executed along the scribe line S as illustrated in FIG. 9 in order to cut out the effective surface portion Ga of the tempered glass sheet G after the forming of the preparatory scribe line RS, the scribe line S, and the auxiliary scribe line HS is finished, the bending moment is applied onto the peripheries of the auxiliary scribe line HS and the preparatory scribe line RS as indicated by the blank arrows in FIG. 9, to thereby execute the snapping along the auxiliary scribe line HS and the preparatory scribe line RS. Thus, the actions and effects as described below can be obtained.

Herein, how the snapping is executed along the auxiliary scribe line HS and the preparatory scribe line RS is entirely the same. Therefore, description is given of only how the snapping is executed along the auxiliary scribe line HS that extends from the edge portion E of the tempered glass sheet G to the linear part T1 of the scribe line S as a representative example.

When the snapping is executed along the auxiliary scribe line HS, a cut portion CU (cleaved portion) is formed along the auxiliary scribe line HS along with the execution of the snapping as illustrated in FIG. 10. At this time, as illustrated in FIG. 10, the cut portion CU further propagates to the scribe line S on the terminal end HSE side of the auxiliary scribe line HS. With this, the cut portion CU that continues from the scribe line S to the edge portion E is formed on the non-effective surface portion Gb of the tempered glass sheet G.

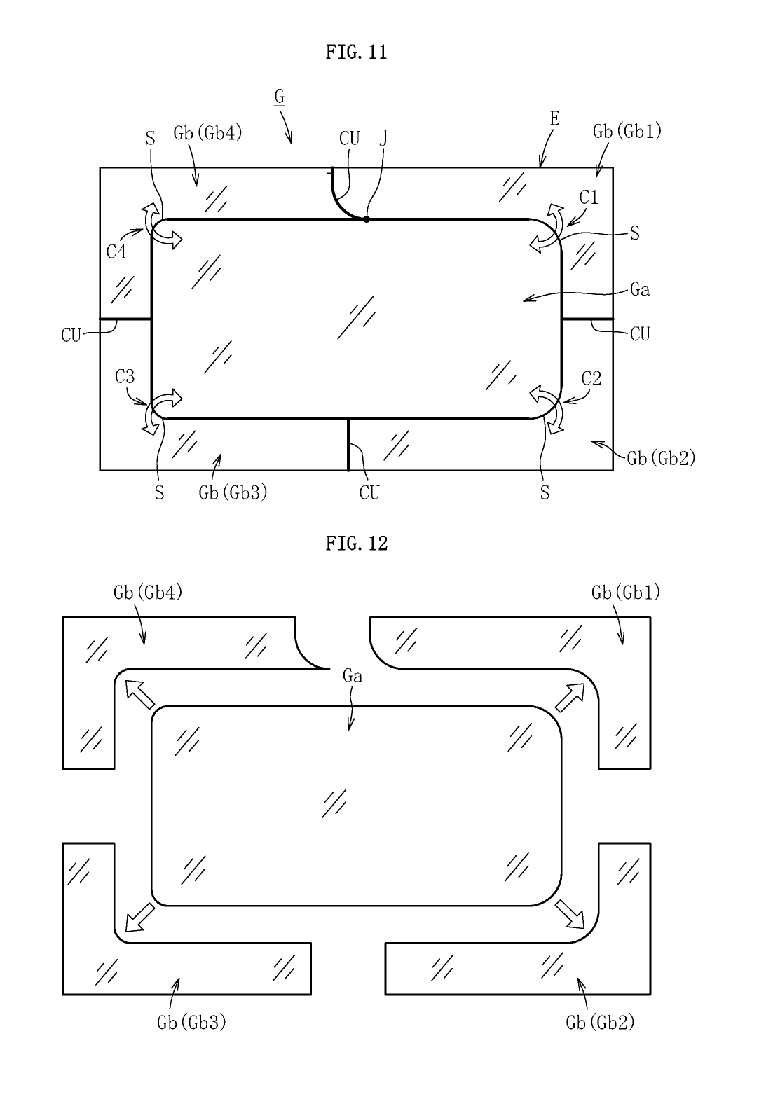

In addition, the cut portion CU having reached the scribe line S thereafter propagates along the scribe line S. Due to the foregoing, when the snapping is executed along the scribe line S (curved parts C1 to C4) as illustrated in FIG. 11 after the execution of the snapping along the auxiliary scribe line HS and the preparatory scribe line RS, in the non-effective surface portion Gb, non-effective surface portions Gb1 to Gb4 split by the cut portions CU can be bent separately and independently in each corresponding direction as indicated by the blank arrows.

Further, in a part in which the cut portion CU has already propagated along the scribe line S, it is not necessary to bend the tempered glass sheet G in a direction corresponding to the part. That is, it is not necessary to bend the tempered glass sheet G simultaneously in various directions along with the execution of the snapping along the scribe line S, and it is possible to limit the bending directions. As a result, the contact between the opposing cut surfaces of the effective surface portion Ga and the non-effective surface portion Gb can be suppressed to the extent possible.

Further, when the auxiliary scribe line HS is formed, the terminal end HSE of the auxiliary scribe line HS is not joined to the scribe line S. Therefore, it is possible to avoid the occurrence of a situation where a crack generated from the auxiliary scribe line HS propagates to the effective surface portion Ga due to the tensile stress applied to the tensile stress layer A of the tempered glass sheet G.

Note that, this effect is further enhanced when the separation distance D2 (=2 mm) between the terminal end HSE of the auxiliary scribe line HS and the scribe line S is set to 0.5 times or more and 3 times or less of the diameter HD (=2 mm) of the scribing wheel H. That is, with this, when the auxiliary scribe line HS is formed, the propagation of the crack generated from the auxiliary scribe line HS to the effective surface portion Ga can be avoided more suitably. Further, when the separation distance D2 between the terminal end HSE of the auxiliary scribe line HS and the scribe line S is excessively long, during the execution of the snapping along the auxiliary scribe line HS, the cut portion CU may propagate in an unintended direction instead of propagating to the scribe line S on the terminal end HSE side of the auxiliary scribe line HS. However, when the separation distance D2 is 0.5 times or more and 3 times or less of the diameter HD of the scribing wheel H, it is possible to suitably prevent the occurrence of such a situation.

Further, the starting end HSS of the auxiliary scribe line HS is positioned at the edge portion E of the non-effective surface portion Gb of the tempered glass sheet G, and hence the auxiliary scribe line HS can be formed to have a depth suited to the operation of cutting by snapping over an entire length from the edge portion E serving as the starting end HSS of the auxiliary scribe line HS to the terminal end HSE. Therefore, the snapping can be reliably executed along the auxiliary scribe line HS.

In addition, the plurality of auxiliary scribe lines and the preparatory scribe line RS are formed, and hence, after the execution of the snapping along the plurality of auxiliary scribe lines and the preparatory scribe line RS, the non-effective surface portion Gb is split into four by the cut portions CU formed in the non-effective surface portion Gb. Therefore, even when each of the non-effective surface portions Gb1 to Gb4 is moved in a direction along a diagonal line of the effective surface portion Ga so as to be removed as illustrated in FIG. 12 after the execution of the snapping along the scribe line S (curved parts C1 to C4), the cut surface of each of the non-effective surface portions Gb1 to Gb4 split into four and the cut surface of the effective surface portion Ga can be separated away from each other easily without being brought into contact with each other.

Further, by forming the auxiliary scribe line HS toward the linear parts T2 to T4 of the scribe line S and forming the auxiliary scribe line HS linearly over an entire length from the edge portion E of the non-effective surface portion Gb of the tempered glass sheet G to the terminal end thereof in a direction perpendicular to the linear parts T2 to T4 of the scribe line S, the following effect was also able to be obtained. That is, when the tempered glass sheet G was cut along the scribe line S, it was possible to suitably avoid the generation of the uncut portion of the effective surface portion Ga.

Now, a method of scribing a tempered glass sheet according to a second embodiment of the present invention is described with reference to the accompanying drawings. Note that, in the description of the methods of scribing a tempered glass sheet according to the second embodiment and third to tenth embodiments of the present invention described below, the elements already described in the method of scribing a tempered glass sheet according to the first embodiment are represented by the same reference symbols in the drawings for illustrating each of the embodiments, and redundant description of those elements is therefore omitted herein.

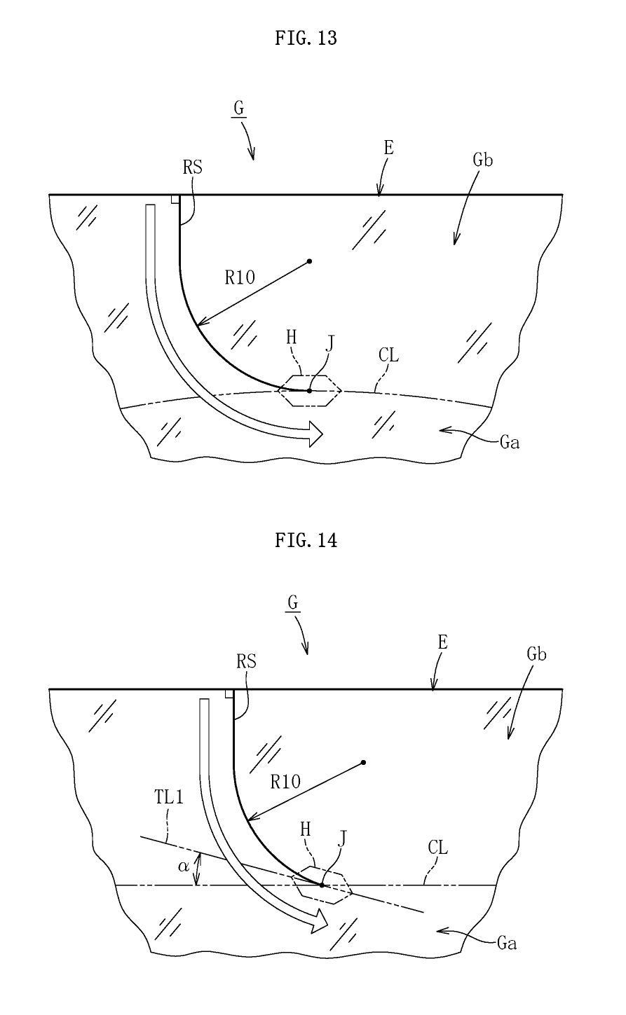

FIG. 13 is an enlarged view of a vicinity of a preparatory scribe line in the method of scribing a tempered glass sheet according to the second embodiment of the present invention. The method of scribing a tempered glass sheet according to the second embodiment is different from the method of scribing a tempered glass sheet according to the first embodiment in that the shape of the effective surface portion Ga is different in the tempered glass sheet G for which the method is carried out. In the effective surface portion Ga, an outer peripheral profile is defined by only a curved line (only a part is illustrated), and along with this, the preset cutting line CL includes only a curved line.

Now, the method of scribing a tempered glass sheet according to the second embodiment of the present invention, and the actions and effects thereof are described. Note that, in the following description, only the points different from those of the method of scribing a tempered glass sheet according to the first embodiment are described.

In the method of scribing a tempered glass sheet according to the second embodiment, the preparatory scribe line RS is smoothly joined to the preset cutting line CL while being curved so as to be brought into contact therewith at a position having a minimum curvature of the preset cutting line CL (joining point J in this embodiment). In this method, the actions and effects similar to those of the method of scribing a tempered glass sheet according to the first embodiment can also be obtained.

Now, the method of scribing a tempered glass sheet according to the third embodiment of the present invention, and the actions and effects thereof are described with reference to the accompanying drawings. Note that, in the following description, only the points different from those of the method of scribing a tempered glass sheet according to the first embodiment are described.

FIG. 14 is an enlarged view of a vicinity of the preparatory scribe line in the method of scribing a tempered glass sheet according to the third embodiment of the present invention. The method of scribing a tempered glass sheet according to the third embodiment is different from the method of scribing a tempered glass sheet according to the first embodiment in that the preparatory scribe line RS and the preset cutting line CL form an angle at the joining point J.

Herein, in this embodiment, a tangent TL1 of the preparatory scribe line RS and the preset cutting line CL form an angle α at the joining point J, and the degree of a is preferably 10° or less. In this method, the actions and effects similar to those of the method of scribing a tempered glass sheet according to the first embodiment can also be obtained.

Now, the method of scribing a tempered glass sheet according to the fourth embodiment of the present invention, and the actions and effects thereof are described with reference to the accompanying drawings. Note that, in the following description, only the points different from those of the method of scribing a tempered glass sheet according to the first embodiment are described.

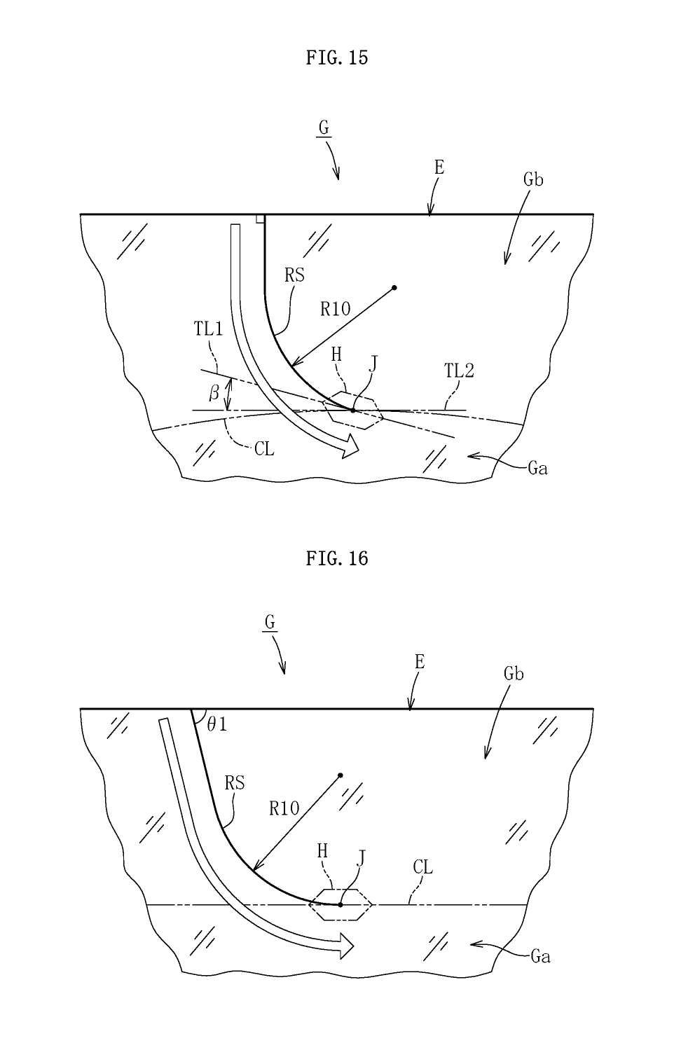

FIG. 15 is an enlarged view of a vicinity of the preparatory scribe line in the method of scribing a tempered glass sheet according to the fourth embodiment of the present invention. The method of scribing a tempered glass sheet according to the fourth embodiment is different from the method of scribing a tempered glass sheet according to the first embodiment in that the shape of the effective surface portion Ga is different in the tempered glass sheet G for which the method is carried out and the preparatory scribe line RS and the preset cutting line CL form an angle at the joining point J.

In the effective surface portion Ga, an outer peripheral profile is defined by only a curved line (only a part is illustrated), and along with this, the preset cutting line CL includes only a curved line. In the method of scribing a tempered glass sheet according to the fourth embodiment, the preparatory scribe line RS is smoothly joined to the preset cutting line CL while being curved at a position having a minimum curvature of the preset cutting line CL (joining point J in this embodiment).

Herein, in this embodiment, the tangent TL1 of the preparatory scribe line RS and a tangent TL2 of the preset cutting line CL form an angle β at the joining point J, and the degree of β is preferably 10° or less. In this method, the actions and effects similar to those of the method of scribing a tempered glass sheet according to the first embodiment can also be obtained.

Now, the method of scribing a tempered glass sheet according to the fifth embodiment of the present invention, and the actions and effects thereof are described with reference to the accompanying drawings. Note that, in the following description, only the points different from those of the method of scribing a tempered glass sheet according to the first embodiment are described.

FIG. 16 is an enlarged view of a vicinity of the preparatory scribe line in the method of scribing a tempered glass sheet according to the fifth embodiment of the present invention. The method of scribing a tempered glass sheet according to the fifth embodiment is different from the method of scribing a tempered glass sheet according to the first embodiment in that the starting end of the preparatory scribe line RS is formed without moving the scribing wheel H in a direction orthogonal to the edge portion E.

Herein, in this embodiment, the starting end of the preparatory scribe line RS is formed by moving the scribing wheel H in a direction inclined at an angle θ1 with respect to the edge portion E of the tempered glass sheet G. Note that, the degree of θ1 is preferably within a range of 90±45° (45°≦θ1≦135°). In this method, the actions and effects similar to those of the method of scribing a tempered glass sheet according to the first embodiment can also be obtained.

Now, the method of scribing a tempered glass sheet according to the sixth embodiment of the present invention is described with reference to the accompanying drawings. Note that, in the following description, only the points different from those of the method of scribing a tempered glass sheet according to the first embodiment are described.

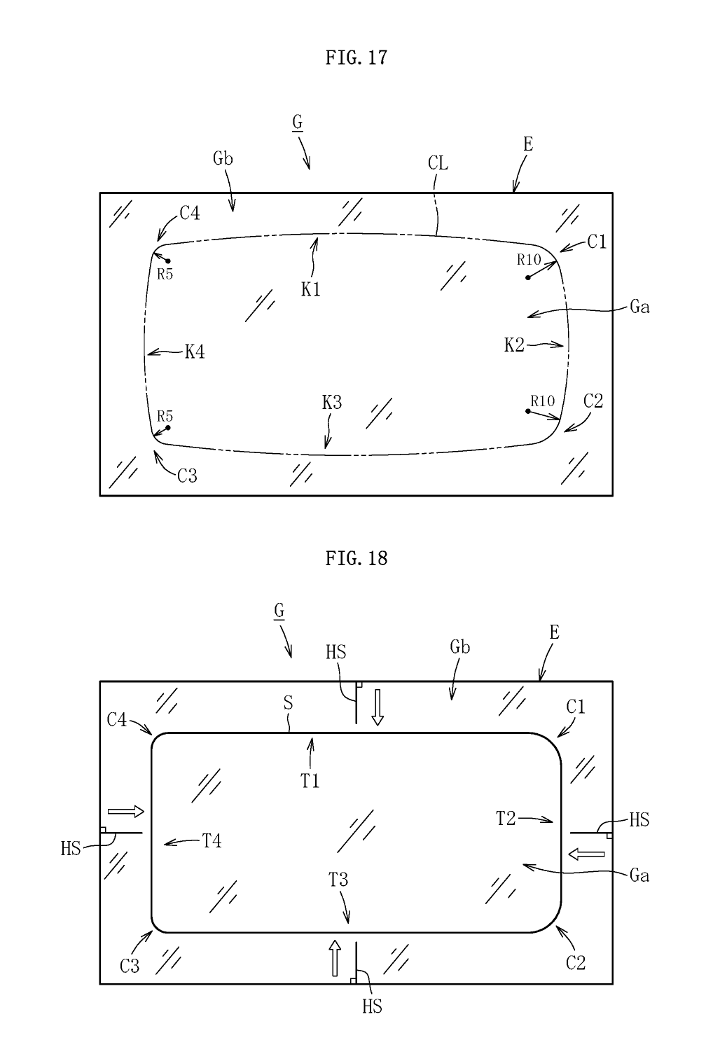

FIG. 17 is a plan view for illustrating the tempered glass sheet G for which the method of scribing a tempered glass sheet according to the sixth embodiment of the present invention is carried out. Note that, the dimensions (width×length×height) of the tempered glass sheet G illustrated in FIG. 17 are the same as those of the tempered glass sheet G in the first embodiment. The method of scribing a tempered glass sheet according to the second embodiment is different from the method of scribing a tempered glass sheet according to the first embodiment in that the configuration of the preset cutting line CL serving as the boundary between the effective surface portion Ga and the non-effective surface portion Ga is different.

In this embodiment, unlike the first embodiment, the preset cutting line CL includes the curved parts C1 to C4 along the corner portions and substantially linear parts K1 to K4 that connect the curved parts C1 to C4 to each other and that can be considered as substantially straight lines due to the significantly large radius of curvature. Each of the substantially linear parts K1 to K4 is an arc curved with a uniform curvature, and the distance from a chord of the arc to a part that most protrudes on the arc is set to 1 mm or less (preferably 500 μm or less). Thus, each of the substantially linear parts K1 to K4 can be considered as a substantially straight line. Herein, in this embodiment, the other parts of the boundary between the effective surface portion Ga and the non-effective surface portion Gb are formed of the substantially linear parts K1 to K4. With this, the effective surface portion Ga surrounded by the preset cutting line CL has a substantially rectangular shape having curved corner portions in the same way as in the first embodiment.

Now, the method of scribing a tempered glass sheet according to the sixth embodiment of the present invention, and the actions and effects thereof are described.

In the method of scribing a tempered glass sheet according to the sixth embodiment, how the scribe line S is formed at the substantially linear parts K1 to K4 is the same as how the scribe line S is formed at the linear parts T1 to T4 in the first embodiment. Further, how the scribe line S is formed at the curved parts C1 to C4 is also the same as that of the first embodiment. Therefore, in the method of scribing a tempered glass sheet according to the sixth embodiment, the actions and effects similar to those of the method of scribing a tempered glass sheet according to the first embodiment can also be obtained.

Now, the methods of scribing a tempered glass sheet according to the seventh to tenth embodiments of the present invention, and the actions and effects thereof are described with reference to the accompanying drawings. Note that, in the following description, only the points different from those of the method of scribing a tempered glass sheet according to the first embodiment are described.

FIG. 18 to FIG. 21 are plan views for illustrating the methods of scribing a tempered glass sheet according to the seventh to tenth embodiments of the present invention. The method of scribing a tempered glass sheet according to each of those embodiments is different in common from the method of scribing a tempered glass sheet according to the first embodiment in that a new auxiliary scribe line HS is formed in place of the preparatory scribe line RS. Note that, the scribing wheel H for forming the auxiliary scribe line HS is omitted in FIG. 18 to FIG. 21.

In the method of scribing a tempered glass sheet according to the seventh embodiment illustrated in FIG. 18, the new auxiliary scribe line HS is formed from the edge portion E of the non-effective surface portion Gb of the tempered glass sheet G toward the linear part T1 of the scribe line S. How the new auxiliary scribe line HS is formed is the same as that of the auxiliary scribe line HS formed toward each of the linear parts T2 to T4.

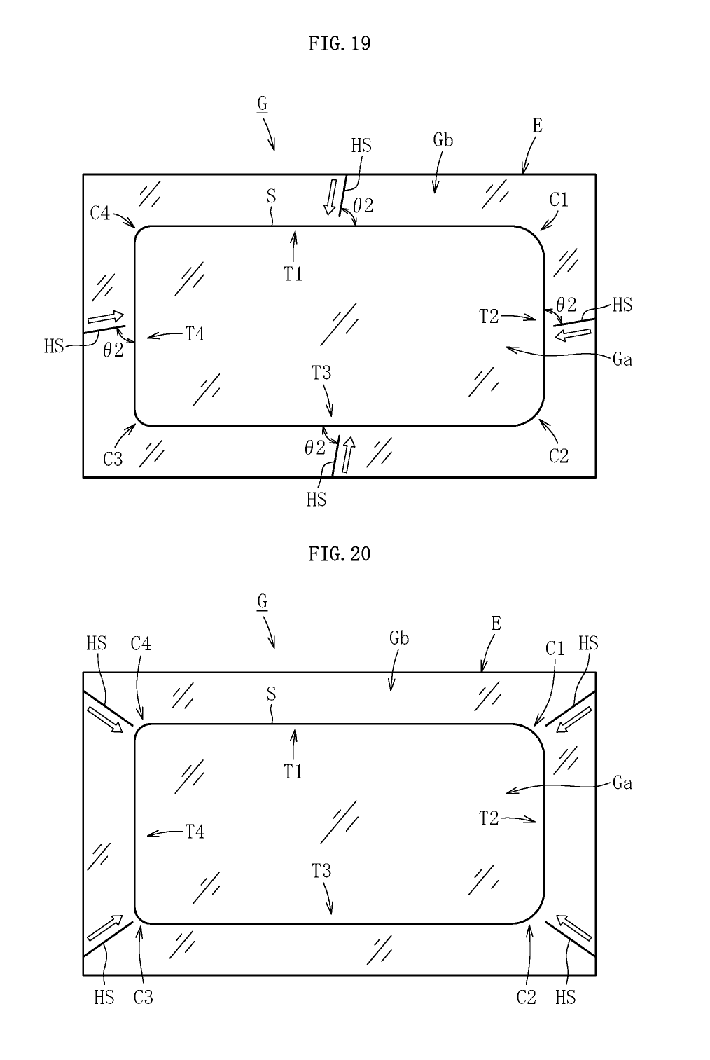

In the method of scribing a tempered glass sheet according to the eighth embodiment illustrated in FIG. 19, none of the auxiliary scribe lines HS is formed along a direction perpendicular to each of the linear parts T1 to T4 from the edge portion E of the non-effective surface portion Gb of the tempered glass sheet G, and the auxiliary scribe line HS and each of the linear parts T1 to T4 forms an inclination angle θ2. Further, the auxiliary scribe lines HS formed toward the linear parts T1 and T3 and the auxiliary scribe lines HS formed toward the linear parts T2 and T4 are inclined in opposite directions. Herein, the value of the inclination angle θ2 can be set to from 15° to 85°, preferably from 30° to 70°.

In the method of scribing a tempered glass sheet according to the ninth embodiment illustrated in FIG. 20, all the auxiliary scribe lines HS are formed from the edge portion E of the non-effective surface portion Gb of the tempered glass sheet G toward each of the curved parts C1 to C4 instead of each of the linear parts T1 to T4.

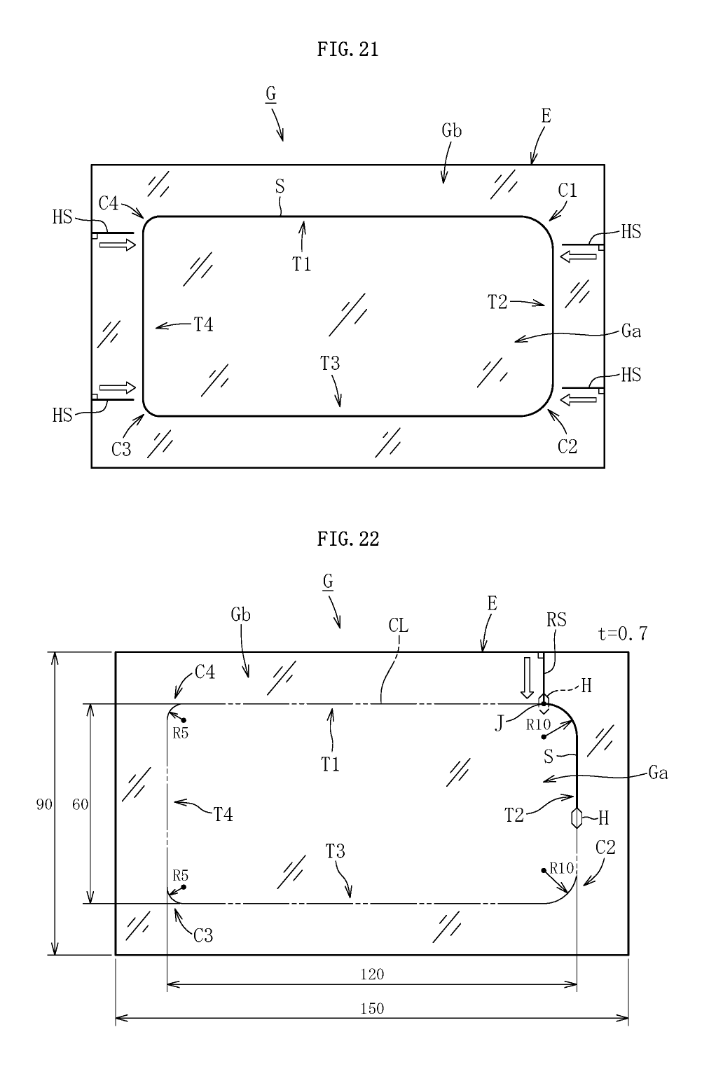

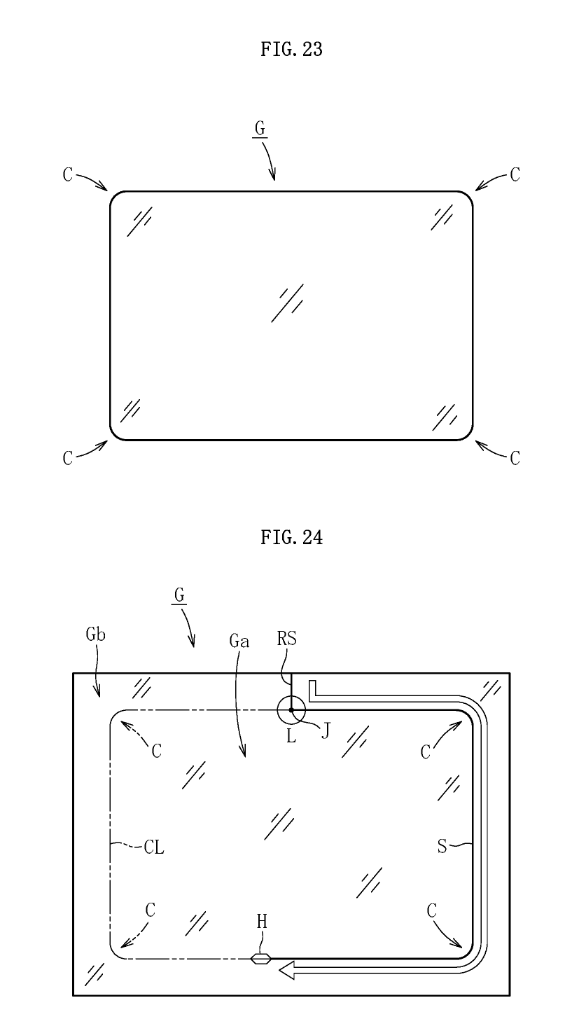

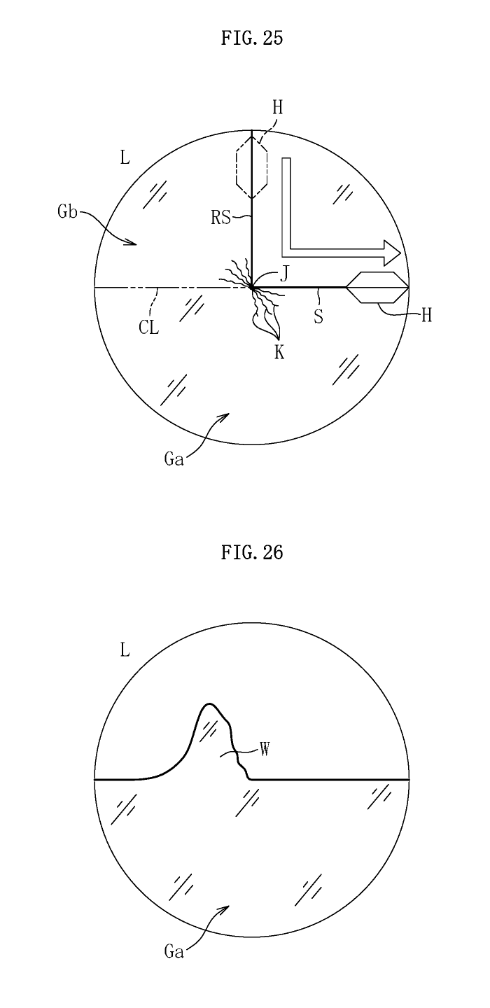

In the method of scribing a tempered glass sheet according to the tenth embodiment illustrated in FIG. 21, the auxiliary scribe lines HS are formed from the edge portion E of the non-effective surface portion Gb of the tempered glass sheet G toward both ends of the linear part T2 or both ends of the linear part T4.

In the methods of scribing a tempered glass sheet according to the seventh to tenth embodiments, the actions and effects similar to those of the method of scribing a tempered glass sheet according to the first embodiment can also be obtained. Note that, in those embodiments, the respective auxiliary scribe lines HS are formed at positions point symmetric with respect to the center of the surface of the tempered glass sheet G.

Herein, in the case of the seventh and eighth embodiments, when the snapping is executed along the auxiliary scribe line HS, the cut portion CU is formed in the same way as in the first embodiment. On the other hand, in the case of the ninth embodiment, when the snapping is executed along the auxiliary scribe line HS, the cut portion CU propagates along each of the curved parts C1 to C4 after reaching the scribe line S. Further, in the case of the tenth embodiment, when the snapping is executed along the auxiliary scribe line HS, the cut portion CU propagates along each of the curved parts C1 to C4 and each of the linear parts T1 to T4 after reaching the scribe line S.

Further, in the case of the seventh embodiment, when each of the non-effective surface portions Gb split by the cut portions CU is removed after the execution of the snapping along the scribe line S, each of the non-effective surface portions Gb is removed in the same way as in the first embodiment. Further, in the case of the eighth embodiment, when each of the non-effective surface portions Gb split by the cut portions CU is removed after the execution of the snapping along the scribe line S, the non-effective surface portions Gb along the curved parts C2 and C4 are first removed in a direction along a diagonal line (diagonal line connecting C2 and C4) of the effective surface portion Ga. Then, the non-effective surface portions Gb along the curved parts C1 and C3 are removed in a direction along a diagonal line (diagonal line connecting C1 and C3) of the effective surface portion Ga. In addition, in the case of the ninth and tenth embodiments, when each of the non-effective surface portions Gb split by the cut portions CU is removed after the execution of the snapping along the scribe line S, each of the non-effective surface portions Gb is removed so that parts extending linearly of the opposing cut surfaces of the effective surface portion Ga and the non-effective surface portion Gb are separated away from each other.

Note that, the method of scribing a tempered glass sheet according to the present invention is not limited to each of the above-mentioned embodiments. For example, in each of the above-mentioned embodiments, the case of cutting out the effective surface portion from the rectangular tempered glass sheet is described. However, the present invention may be applied to the case of cutting out the effective surface portion from the tempered glass sheet having any shape (other than the rectangular shape). Further, in the method of scribing a tempered glass sheet according to the present invention, the dimensions of the tempered glass sheet for which the method is carried out are not limited to each of the above-mentioned embodiments, and the present invention is applicable to the tempered glass sheet having any dimensions.

Further, in each of the above-mentioned embodiments, the starting end of the preparatory scribe line is positioned at the edge portion of the tempered glass sheet. The present invention is not limited thereto, and any position in the non-effective surface portion may be used as the starting end of the preparatory scribe line. In addition, in each of the above-mentioned embodiments, the terminal end of the scribe line and the joining point are preferably separated away from each other. However, it is not necessarily required to separate the terminal end and the joining point away from each other, and the terminal end of the scribe line and the joining point may be matched.

Further, in each of the above-mentioned embodiments, the preparatory scribe line is configured to include both the linear part and the curved part, but may include only the curved part. Further, in each of the above-mentioned embodiments, the preparatory scribe line is curved with a predetermined radius of curvature. However, the present invention is not limited thereto, and the preparatory scribe line may be formed so that the radius of curvature changes in the middle, for example, the radius of curvature of the preparatory scribe line is larger in the vicinity of the terminal end than in the vicinity of the starting end.

Further, in each of the above-mentioned embodiments, when the preset cutting line includes a straight line, the preparatory scribe line is joined to the straight line, and when the preset cutting line includes only a curved line, the preparatory scribe line is joined at a position having a minimum curvature in the curved line. However, the present invention is not limited thereto, and even when the preset cutting line includes a straight line, the preparatory scribe line may be joined to the curved line or may be joined at a position other than the position having a minimum curvature.

Further, in the first, third, fifth, and seventh to tenth embodiments, the preset cutting line serving as the boundary between the effective surface portion and the non-effective surface portion includes the curved parts and the linear parts connecting the curved parts to each other. Further, in the sixth embodiment, the preset cutting line includes the curved parts and the substantially linear parts connecting the curved parts to each other. However, the present invention is not limited thereto, and for example, in the first, third, fifth, and seventh to tenth embodiments, the preset cutting line may be formed by replacing only a part of the linear parts at four positions with the substantially linear part.

Further, in each of the above-mentioned embodiments, although the self-propagation of the split crack is urged at the curved part of the boundary between the effective surface portion and the non-effective surface portion along the corner portion, it is not necessarily required to cause the split crack to self-propagate. For example, the separation between the effective surface portion and the non-effective surface portion at the curved part can be executed suitably merely by forming the median crack deeper at the curved part than at the other parts (linear part and substantially linear part in the above-mentioned embodiments) because bending moment required for cutting the tempered glass sheet by snapping becomes smaller even when the self-propagation of the split crack does not occur.

Further, in each of the above-mentioned embodiments, the starting end of the auxiliary scribe line is positioned at the edge portion of the non-effective surface portion of the tempered glass sheet. However, it is not necessarily required to use the edge portion as the starting end, and any position in the non-effective surface portion can be used as the starting end. Note that, in such a case, it is preferred that the starting end of the auxiliary scribe line be located in the vicinity of the edge portion.

Further, in the first to sixth embodiments, three auxiliary scribe lines are formed, and in the seventh to tenth embodiments, four auxiliary scribe lines are formed. The number of the auxiliary scribe lines may be increased. In this case, as the number of the auxiliary scribe lines is larger, the non-effective surface portion is split in a larger number by the cut portions formed in the non-effective surface portion after the execution of the snapping along the auxiliary scribe line. Therefore, when the snapping is executed along the scribe line after the execution of the snapping along the auxiliary scribe line, the bending directions can be limited when each of the non-effective surface portions split by the cut portions is bent.

Further, regarding the number of the auxiliary scribe lines, the auxiliary scribe lines may be formed only in a smaller number as compared to that in each of the above-mentioned embodiments. However, it is preferred that two or more auxiliary scribe lines be formed from the viewpoint of preventing the contact between the opposing cut surfaces of the effective surface portion and the non-effective surface portion. Note that, when the effective surface portion having a typical shape is cut out from the rectangular tempered glass sheet in the case of forming only two auxiliary scribe lines, it is preferred that one auxiliary scribe line be formed at each of two parallel sides of the rectangular tempered glass sheet and the auxiliary scribe lines be formed so as to be opposed to each other.

In addition, in each of the above-mentioned embodiments, although the auxiliary scribe line is formed linearly over an entire length from the starting end to the terminal end thereof, the auxiliary scribe line may be formed as a curved line that can be considered as a substantially straight line.

Note that, the method of scribing a tempered glass sheet according to the present invention is assumed to be applicable to the following case. That is, for example, there is assumed a case of cutting out the effective surface portion having an oval shape from the tempered glass sheet. In this case, the median crack is formed deeper at the part having a large curvature of the boundary between the effective surface portion and the non-effective surface portion. With this, the effective surface portion and the non-effective surface portion are separated more easily at the part having a large curvature than at the part having a small curvature, and thus it is assumed that the effective surface portion can be smoothly cut out from the tempered glass sheet.

### EXAMPLES

A preparatory scribe line and a scribe line were formed on a tempered glass sheet by the above-mentioned method of scribing a tempered glass sheet according to the first embodiment of the present invention as an example of the present invention, and by a method of scribing a tempered glass sheet according to a comparative example described below. Then, bending moment was applied onto peripheries of the thus formed preparatory scribe line and scribe line so as to cut (cleave) the tempered glass sheet by snapping into an effective surface portion and a non-effective surface portion. After that, it was investigated whether or not an uncut portion was generated in the effective surface portion.

Now, an embodiment of the example is the same as the above-mentioned method of scribing a tempered glass sheet according to the first embodiment, and hence only an embodiment of the comparative example is described. Note that, in the description of the comparative example, the elements already described in the above-mentioned method of scribing a tempered glass sheet according to the first embodiment are represented by the same reference symbols in the drawings for illustrating the comparative example, and redundant description of those elements is therefore omitted herein.

In the comparative example, as illustrated in FIG. 22, the preparatory scribe line RS was joined to a connection portion between the linear part T1 and the curved part C1 on the preset cutting line CL by moving the scribing wheel H in a direction orthogonal to the linear part T1 of the preset cutting line CL. After that, the moving direction of the scribing wheel H was changed by 90°, and the scribe line S continuing from the preparatory scribe line RS was formed into a closed-loop shape along the preset cutting line CL. Note that, the moving velocity of the scribing wheel H at a time of forming the preparatory scribe line RS and the scribe line S and the pressing pressure of the scribing wheel H for pressing the surface of the tempered glass sheet G are entirely the same as those of the above-mentioned method of scribing a tempered glass sheet according to the first embodiment.

Now, the results (presence or absence of the uncut portion in the effective surface portion) of the investigation are described. In the example, it was possible to prevent the generation of the uncut portion of the effective surface portion Ga. On the other hand, in the comparative example, the uncut portion protruding in a horn shape was generated in the vicinity of the joining point J. Those results are assumed to be caused for the following reason. In the comparative example, when the forming of the scribe line S continuing from the preparatory scribe line RS was started, the moving direction of the scribing wheel H was changed abruptly, whereas in the example, the scribing wheel H was moved so that the preparatory scribe line RS was smoothly joined to the preset cutting line while being curved.

It can be presumed from the above description that, in the method of scribing a tempered glass sheet according to the present invention, when the effective surface portion having an outer peripheral profile including a curved line is cut out from the tempered glass sheet, it is possible to suppress the generation of the uncut portion in the effective surface portion.

### REFERENCE SIGNS LIST

G tempered glass sheet
Ga effective surface portion
Gb non-effective surface portion
E edge portion of tempered glass sheet
A compressive stress layer
DOL thickness of compressive stress layer
B tensile stress layer
CL preset cutting line
T1 to T4 linear part of preset cutting line (scribe line)
C1 to C4 curved part of preset cutting line (scribe line)
K1 to K4 substantially linear part of preset cutting line
RS preparatory scribe line
S scribe line
SE terminal end of scribe line
HS auxiliary scribe line
HSS starting end of auxiliary scribe line
HSE terminal end of auxiliary scribe line
MC median crack
X depth of median crack at linear part
Y depth of median crack at curved part
Z depth of median crack at curved part
CR split crack
J joining point between preparatory scribe line and preset cutting line
TL1 tangent of preparatory scribe line
TL2 tangent of preset cutting line
α angle formed between tangent of preparatory scribe line and preset cutting line
β angle formed between tangent of preparatory scribe line and tangent of preset cutting line
θ1 angle formed between preparatory scribe line and edge portion
D1 separation distance between terminal end of scribe line and joining point
H scribing wheel
HD diameter of scribing wheel
D2 separation distance between terminal end of auxiliary scribe line and scribe line
F pressing force
moving velocity
C corner portion

1. A method of scribing a tempered glass sheet, which involves moving a rotary scribing blade along a preset cutting line having a closed-loop shape and serving as a boundary between an effective surface portion having an outer peripheral profile including a curved line and a non-effective surface portion surrounding the effective surface portion, to thereby form a scribe line for cutting the tempered glass sheet into the effective surface portion and the non-effective surface portion,
the method comprising:
forming a preparatory scribe line to be smoothly joined to the preset cutting line while being curved from the non-effective surface portion to the preset cutting line with use of the rotary scribing blade; and
forming, after forming the preparatory scribe line, the scribe line that continues from the preparatory scribe line with use of the rotary scribing blade.

2. The method of scribing a tempered glass sheet according to claim 1,
wherein the effective surface portion has a substantially rectangular shape including curved corner portions, and
wherein the scribe line is formed so that a depth of the scribe line becomes larger at a curved part of the boundary between the effective surface portion and the non-effective surface portion along each of the curved corner portions than at other parts of the boundary between the effective surface portion and the non-effective surface portion.

3. The method of scribing a tempered glass sheet according to claim 1, further comprising forming, by moving a scribing blade, an auxiliary scribe line extending toward the scribe line with the non-effective surface portion being a starting end of the auxiliary scribe line, and having a terminal end prevented from being joined to the scribe line.

4. The method of scribing a tempered glass sheet according to claim 1, wherein a point at which the preparatory scribe line is joined to the preset cutting line and a terminal end of the scribe line are separated away from each other.

5. A method of scribing a tempered glass sheet, which involves moving a scribing blade along a preset cutting line having a closed-loop shape and serving as a boundary between an effective surface portion having an outer peripheral profile including a curved line and a non-effective surface portion surrounding the effective surface portion, to thereby form a scribe line for cutting the tempered glass sheet into the effective surface portion and the non-effective surface portion,
the method comprising forming, by moving the scribing blade, an auxiliary scribe line extending toward the scribe line with the non-effective surface portion being a starting end of the auxiliary scribe line, and having a terminal end prevented from being joined to the scribe line.

6. The method of scribing a tempered glass sheet according to claim 5,
wherein the effective surface portion has a substantially rectangular shape including curved corner portions, and
wherein the scribe line is formed so that a depth of the scribe line becomes larger at a curved part along each of the curved corner portions than at other parts.

7. A method of scribing a tempered glass sheet, which involves moving a scribing blade along a boundary between an effective surface portion having a substantially rectangular shape including curved corner portions and a non-effective surface portion surrounding the effective surface portion, to thereby form a scribe line for cutting the tempered glass sheet into the effective surface portion and the non-effective surface portion,
the method comprising forming the scribe line so that a depth of the scribe line becomes larger at a curved part of the boundary between the effective surface portion and the non-effective surface portion along each of the curved corner portions than at other parts of the boundary between the effective surface portion and the non-effective surface portion.
